(19) United States
(12) Patent Application Publication
(10) Pub. No.: US 2002/0176804 A1
(43) Pub. Date: Nov. 28, 2002

(54) Microfluidic substrate assembly and method for making same

(75) Inventors: David Strand, Sherborn, MA (US); Joseph Antocci, Leominster, MA (US); Peter Myers, Bromborough (GB); David Barrow, Cardiff (GB); Joseph Cefai, Swansea (GB); Tim Myers, Wirral (GB)

Correspondence Address: BANNER & WITCOFF, LTD., 28 STATE STREET, 28th FLOOR, BOSTON, MA, 02109, US

(73) Assignee: Protasis Corporation, Marborough, MA

(21) Appl. No.: 10/033,315

(22) Filed: Dec. 27, 2001

Related U.S. Application Data
(63) Continuation of application No. PCT/US01/31333, filed on Oct. 5, 2001.
(60) Provisional application No. 60/239,063, filed on Oct. 6, 2000.
(60) Provisional application No. 60/239,010, filed on Oct. 6, 2000.
(60) Provisional application No. 60/238,805, filed on Oct. 6, 2000.
(60) Provisional application No. 60/238,390, filed on Oct. 6, 2000.

(51) Int. Cl. B01L 3/00

(52) U.S. Cl. 422/100

(57) ABSTRACT

A novel microfluidic substrate assembly and method for making same are disclosed. The substrate assembly comprises a multi-layer laminated substrate defining at least one fluid inlet port and at least one microscale fluid flow channel within the multi-layer substrate in fluid communication with the inlet port for transport of fluid. The substrate assembly may optionally comprise additional components and elements located within the substrate assembly or attached to the substrate assembly.

### CROSS-REFERENCED APPLICATIONS

This application claims priority to commonly assigned U.S. Patent Application No. 60/239,010 titled “Microfluidic Substrate Assembly and a Method for Making Same” and filed on Oct. 6, 2000, commonly assigned U.S. Patent Application No. 60/239,063 titled “Liquid Separation Column Smart Cartridge” and filed on Oct. 6, 2000, commonly assigned U.S. Patent Application No. 60/238,805 titled “Liquid Separation Column Smart Cartridge with Encryption Capability” and filed on Oct. 6, 2000, commonly assigned U.S. Patent Application No. 60/238,390 titled “Microfluidic Substrate Assembly and a Method for Making Same” and filed on Oct. 6, 2000, the entire disclosure of each of which is hereby incorporated herein by reference for all purposes.

### FIELD OF INVENTION

The present invention relates to fluid-handling substrate devices and more particularly to microfluidic substrate assemblies and to methods for making certain preferred embodiments of such microfluidic substrate assemblies.

### BACKGROUND

Systems for biochemical, chemical, and molecular analysis can be miniaturized as substrates with multifunctional capabilities including, for example, chemical, optical, fluidic, electronic, acoustic, and/or mechanical functionality. Miniaturization of these systems offers several advantages, including increased portability and lower production cost. Such devices can be fabricated from a diverse ensemble of materials including, for example, plastics or polymers, metals, silicon, ceramics, paper, and composites of these and other materials. Typically, such substrates include fluid channels extending within them for the transport and/or analysis of fluids or components contained in the fluids. Additionally, the channels may contain fragile or environmentally sensitive structures, such as materials, architecture and/or devices used for analyzing the fluids or components contained therein. Mesoscale sample preparation devices for providing microvolume test samples are described in U.S. Pat. No. 5,928,880 to Wilding et al. Devices for analyzing a fluid sample, comprising a solid substrate microfabricated to define at least one sample inlet port and a mesoscale flow channel extending from the inlet port within the substrate for transport of a fluid sample are described in U.S. Pat. No. 5,304,487.

Currently known miniaturized fluid-handling devices have not met all of the needs of industry. Also, methods for assembling miniaturized fluid-handling substrates are inadequate in one or more respects. The microfabrication of solid substrates to produce mesoscale devices is not adequately suited to cost effective, flexible production of suitable fluid handling devices. Current thermal welding methods, for example, are unsuitable or ineffective for fluid-handling substrates having, i.e., incorporating or embodying, environmentally sensitive elements. More specifically, as noted above, the channels formed in substrates produced by thermally welding together pieces, layers, or the like may contain environmentally sensitive elements, such as microstructures or devices that could be damaged by exposure to high temperature or intense radiation. Thus, current methods used for welding plastic pieces together may require temperatures and/or pressures that can destroy such environmentally sensitive elements. It is possible that the temperature of a system being welded could reach over 600 degrees centigrade, a temperature that could easily destroy sensitive fluid analysis or detection components, such as a computer processor contained within the channels of a substrate, and could destroy the walls of miniaturized channels, e.g., channels formed by micro-machining in the plastic layers joined together to form a fluid-handling substrate.

Other methods of joining plastic or other substrate pieces together include solvent-based sealing, high pressure and temperature based sealing, and adhesive based sealing. Additional problems exist with these methods used to seal channels. Adhesives require time to cure, which slows manufacturing. Also, adhesives may require difficult control of pressure during assembly, since too little pressure may result in an inadequate seal and excessive pressure can squeeze the adhesive into the channels. Adhesives also must be applied carefully so as not to produce areas that are so thick as to alter the dimensions of the channel. Solvents and the chemicals in adhesives may contaminate the channels and/or otherwise damage the environmentally sensitive elements contained in the channels. Certain components within the solution might dissolve one ore more components in the adhesives which may result in potential interferences in detecting the components of interest in the solution.

Therefore, there exists a need in the art for improved fluid-handling substrates, and for methods for manufacturing fluid-handling substrates that avoid damage to substrate elements and/or heat-sensitive components contained within such substrates. It is a general object of the present invention to provide improved fluid-handling substrates, particularly micro-fluidic substrates, and improved methods of forming such fluid-handling substrates. These and other objects of the invention will be more fully understood from the following disclosure and detailed description of certain preferred embodiments of the invention.

### SUMMARY

In accordance with a first aspect, fluid handling devices are provided, comprising a multi-layer laminated substrate defining at least one fluid inlet port and at least one microscale fluid flow channel (also referred to in some cases here as a microfluidic channel or a microchannel of the multi-layer laminated substrate) within the multi-layer substrate in fluid communication with the inlet port for transport of fluid to be tested, analyzed or operated on. Preferred embodiments of the devices can be utilized in a wide range of automated tests for the analysis of a fluid. As used here fluid refers to gases, liquids, supercritical fluids and the like, optionally containing dissolved species, solvated species and/or particulate matter. Testing or analysis of a fluid has a broad meaning, including any detection, measurement or other determination of the presence of a fluid or of a characteristic or property of the fluid or of a component of the fluid, such as particles, dissolved salts or other solutes or other species in the fluid. Especially preferred embodiments of the fluid handling devices disclosed here are operative to perform liquid separation analyses. That is, the devices perform or are adapted to function in a larger system which performs, any of various different fluid separation test or analysis methods, typically along with ancillary and supporting operations.

In accordance with another aspect, the fluid handling devices include a substrate assembly comprising a multi-layer laminated substrate microfabricated to define at least one microscale fluid flow passage. Numerous materials are suitable for the individual layers of the substrate, depending on the use environment and functionality intended for the device. Suitable materials include, for example, polymers, plastics, e.g. rigid or flexible plastics, glass, ceramic, metal, silicon, etc. and combinations of numerous materials. In certain embodiments, additives, such as carbon black, dyes, titanium dioxide, gold, e.g. electroplated gold or electrolessly plated gold, carbon particles, additional polymers, e.g. a secondary polymer or second phase polymer reactive with the primary polymer of the laminate layer, IR absorbing materials, and the like, may be included, as a surface coating and/or a body filler, in the materials used to form any of the layers of the multi-layer laminated substrate. A layer formed of materials suitable for micromachining may be used, for example, with another layer formed of material compatible with waveguide, thick film, thin film or other surface treatments. Given the benefit of this disclosure, it will be within the ability of those skilled in the art to select materials for the substrate suited to the particular application. The substrate assembly may take any of numerous forms, e.g., a manifold in fluid communication with an instrument, a cartridge, such as the cartridge described in the commonly assigned U.S. Patent Applications incorporated by reference, or a component of a cartridge for performing one or more operations on a fluid, for example, fluid analysis, testing, reactions, detection or the like, such as by gas chromatography, liquid chromatography, electrophoresis, or other fluid separation and analytical techniques. As further discussed below, any one or more of various different operations may be performed by the substrate assembly, employing, for example, heating, cooling, mixing, electrical or electromagnetic or acoustical (e.g., ultrasonic) forces, pressure differentials, etc. Exemplary unit operations which may be performed by various different embodiments of the substrate assembly disclosed here include fluid mixing, reacting, analyzing, extraction, amplification or focusing or concentration, labeling, filtering, selection, purification, etc. Information such as the identity of the substrate assembly, the results of any such operation(s) and/or when they occurred or the conditions at that time may optionally be digitally or otherwise recorded, such as in an on-board memory unit or the like carried by the substrate assembly or by another component of a system in which the substrate assembly is employed or in communication with, either by wire or by wireless communication, for example. One or more of the aforesaid operations may be integrated into the substrate assemblies disclosed herein.

In accordance with another aspect, the substrate assemblies disclosed here are “microfluidic” in that they operate effectively on micro-scale fluid samples, typically having fluid flow rates as low as about 1 ml/min, preferably about 100 ul/min or less, more preferably about 10 ul/min or less, most preferably about 1 ul/min or less, for example about 100 nanoliters/min. Total fluid volume for an LC or other such fluid separation method performed by substrate assemblies disclosed here, e.g., in support of a water quality test to determine the concentration of analytes in the water being tested, in accordance with certain preferred embodiments, can be as small as about 10 ml or less, or 1 ml or less, preferably 100 microliters, more preferably 10 microliters or even 1 microliter or less, for example, about 100 nanoliters. As used herein, the term “microscale” also refers to flow passages or channels and other structural elements of the multi-layer laminated substrate. For example, the one or more microchannels of the substrate preferably have a cross-sectional dimension (diameter, width or height) between about 500 microns and about 100 nanometers. Thus, at the small end of that range, the microchannel has cross-sectional area of about 0.01 square microns. Such microchannels within the laminated substrate, and chambers and other structures within the laminated substrate, when viewed in cross-section, may be triangular, ellipsoidal, square, rectangular, circular or any other shape, with at least one and preferably all of the cross-sectional dimensions transverse to the path of the fluid flow. It should be recognized, that one or more layers of the laminated substrate may in certain embodiments have operative features, such as fluid channels, reaction chambers or zones, accumulation sites etc. that are larger than microscale. Additionally, the multi-layer laminated substrate may be attached to one or more devices that are larger than microscale and optionally have an adaptor such as a valve, for example, to provide a suitable interface with the laminated substrate and/or to regulate the fluid flow rate into the laminated substrate. The multi-layer laminated substrates disclosed here can provide effective fluid analysis systems with good speed of analysis, decreased sample and solvent consumption, the possibility of increased detection efficiency, and in certain embodiments disposable fluid-handling devices.

In accordance with an additional aspect, the microfluidic nature of the substrate assemblies disclosed here provides significant commercial advantage. Less sample fluid is required, which in certain applications can present significant cost reductions, both in reducing product usage (for example, if the test sample is taken from a product stream) and in reducing the waste stream disposal volume. Samples can be concentrated prior to separation and/or entry into the microfluidic substrate assemblies. In addition, the microfluidic substrate assemblies can, in accordance with preferred embodiments, be produced employing micro electromechanical systems (MEMS) and other known techniques suitable for cost effective manufacture of miniature high precision devices. The microscale fluid flow channel(s) of the multi-layer laminated substrate of the microfluidic substrate assembly and other operational features and components of the microfluidic substrate assembly, such as components for liquid chromatography or other fluid separation methods, heating or cooling fluid handled by the assembly, generating electrical or electromagnetic or acoustical (e.g., ultrasonic) forces on the fluid, generating high pressures or pressure differentials, fluid mixing, reacting, analyzing, extraction, amplification or focusing or concentration, labeling, filtering, selection, purification, etc., can be integrated into the multi-layer laminated substrate, mounted onto the substrate as an on-board component or incorporated elsewhere in the microfluidic substrate assembly. Such operational devices, including, for example, devices integrated as an external component-on-board mounted in fluid-tight fashion to any surface of the substrate and/or devices embedded within the body of the substrate, in accordance with preferred embodiments of the microfluidic substrate assembly, are micro-scale devices, as defined above.

In accordance with another aspect, fluid handling devices are provided comprising a multi-layer laminated substrate defining at least one fluid inlet port and at least one microscale fluid flow channel within the multi-layer laminated substrate in fluid communication with the inlet port for transport of fluid to be tested. At least one operative component is mounted aboard the multi-layer laminated substrate in communication with the microscale fluid flow channel. In certain preferred embodiments the mounted component (referred to here also as a “component-on-board” or by similar term) is in fluid communication with the microchannel(s) in the substrate. The component-on-board can be any of numerous components useful for fluid separation methods or other operations. Exemplary components include heaters, coolers, pumps, fluid reservoirs, mixers, e.g. ultrasonic mixers, sensors, the fluid separation conduit cartridges as disclosed in the commonly assigned U.S. Patent Applications incorporated herein by reference, and other devices discussed here. As discussed further below, any necessary or desired function not performed by a suitable component-on-board can be performed by other equipment associated with the microfluidic substrate assembly. As an example of components of the multi-layer laminated substrates disclosed here, or the microfluidic substrate assembly incorporating or integrating such fluid-handling substrate, in certain embodiments will advantageously comprise a heating/cooling element for controlling the temperature of fluid being tested or measured, e.g., an electrical heating element and/or a refrigeration element. An electrical heating element may be integrated into the substrate, with electrical elements for power mated to matching electrical contacts in a larger associated device which receives the substrate. Alternatively, the larger associated device may include internal or external heating devices, such as a laser or other source of electromagnetic energy. A microprocessor may be used to regulate the heating element and/or control other functions of the microfluidic substrate assembly. A thermocouple may also be provided in the substrate in electrical contact with the associated device to allow such microprocessor or other electronic controller to detect and maintain desired fluid temperatures. A cooling element, such as a miniature thermoelectric heat pump (Materials Electronic Products Corp., Trenton, N.J.), may also be included in the associated device for adjusting the temperature of the amplification chamber.

In accordance with another aspect, fluid handling devices are provided comprising a generally planar multi-layer laminated substrate defining at least one fluid inlet port, at least one microscale fluid flow channel at each of more than one level within the multi-layer laminated substrate for transport of fluid to be tested, and at least one microchannel via extending between levels within the multi-layer laminated substrate for fluid communication between microscale fluid flow. Such channels are referred to in some instances below as interlayer microfluidic channels. In preferred embodiments, the microscale fluid flow channels at each of multiple levels within the substrate are formed at the surface-to-surface interfaces between layers of the substrate. Two levels of microchannels are formed, for example, by a PEEK or other plastic plate or disk having micromachined or micromilled grooves on both an upper and lower surface and sandwiched between two other layers of the substrate. A through-hole micromachined or otherwise formed in the plastic plate passing from an upper surface groove to a lower surface groove provides a fluid communication via, e.g. provides a fluid flow channel. In certain preferred embodiments one orboth of the sandwiching layers of the substrate is a flexible sheet or film. As used here, the term “generally planar multi-layer laminated substrate” means card or cartridge-like, optionally being curvo-planar or otherwise irregular, but typically being rectilinear or right-cylindrical, and having a thickness less than about one third, preferably less than one quarter, more preferably less than about one fifth, e.g., about one sixth or less, the largest dimension of the major (i.e., largest) surface of the laminated substrate. The dimensions of the laminated substrate referred to here are measured without including any external components mounted on-board the substrate. Nor do they include electrical leads or connectors or conduits carrying sample fluid to or from the laminated substrate. One or both of the sandwiching layers can be welded or otherwise bonded, selectively or not, to the micromachined layer to provide fluid-tight sealing along the microchannels. Additional levels of microchannels are provided by stacking additional micromachined plates in the substrate. Directional references used here are for convenience only and not intended to limit the orientation in which the multi-layer laminated substrates are used. In general, the multi-layer laminated substrates can be used in any orientation; solely for purposes of discussion here, they are assumed to be in the orientation shown in the drawings appended hereto. One skilled in the art, given the benefit of this disclosure, will recognize that microchannels and vias of the multi-layer laminated substrate can have any suitable configuration including straight, curvo-linear, serpentine or spiral. The cross-sectional configuration of the microchannels can be regular, i.e., uniform, or irregular, to suit the needs of an intended application.

In accordance with another aspect, fluid handling devices are provided comprising a multi-layer laminated substrate defining at least one fluid inlet port and at least one microscale fluid flow channel within the multi-layer substrate in fluid communication with the inlet port for transport of fluid to be tested, wherein at least one layer of the multi-layer laminated substrate is formed of plastic and the substrate assembly is operative and fluid tight at high fluid pressure in the microscale fluid flow channel. Certain preferred embodiments are fluid tight and operative at fluid pressures in excess of 100 psi, preferably in excess of 200 psi, more preferably in excess of 300 psi, most preferably at pressures greater than 500 psi. As used here psi preferably refers to psi gauge as opposed to psi absolute. Especially preferred embodiments are operative, including being fluid-tight along the periphery of the microchannels within the substrate, even at fluid pressure in the microscale fluid flow channel in excess of 1000 psi. Preferred embodiments employing plastic substrate layers in high pressure embodiments provide significant advantages in manufacturing cost and flexibility. In certain preferred embodiments, the microfluidic substrate assembly employs a multi-layer laminated substrate having rigid plates sandwiching plastic layer between them. The plastic layers optionally are welded one to another and the rigid plates sandwiching the multiple plastic layer between them are formed of metal and are fastened directly to each other. As used here, direct fastening means that a bolt or other fastener has compressive contact with the rigid sandwiching plates. Preferably multiple bolts or the like extend from one to the other of the rigid sandwiching plates. In accordance with certain preferred embodiments, grooves for fluid flow channels can be micromachined, laser cut or otherwise milled or formed in the inside surface of one or both metal (or other rigid material) clamping plates that may be, e.g., 3/16 of an inch to 3 inches thick. When the substrate is assembled, a layer of PEEK or other plastic, e.g., 0.003-0.005 inch thick layer of PEEK clamped between the plates, in cooperation with the clamping plates grooves, defines fluid-tight microchannels of the resulting multi-layer laminated substrate. Through holes in the PEEK layer can serve as vertical vias in the substrate to provide fluid communication from microchannels in the inside surface of the top clamping plate to those in the lower clamping plate. FIG. 10 shows an exemplary such embodiment. Bottom clamping plate 110 has microgrooves 114 machined into its inside surface 116. Top clamping plate 112 has similar grooves 118. PEEK layer 120 has microgrooves 122 and through-holes 124. Other configurations will be readily apparent to those skilled in the art given the benefit of this disclosure.

In accordance with another aspect, fluid handling devices are provided comprising a multi-layer laminated substrate defining at least one fluid inlet port, at least one microscale fluid flow channel within the multi-layer substrate in fluid communication with the inlet port for transport of fluid to be tested, and at least one electronic memory unit mounted to the substrate assembly and operatively connected to the another component of the microfluidic substrate assembly. As used here memory unit refers to any device that is operative to store, read, write, and/or read and write information. Preferred memory units include but are not limited to memory chips, e.g., read only memory (ROMs), programmable read only memory (ROMs) erasable programmable read-only memory (EPROMs), electrically erasable programmable read-only memory (EEPROMs), DIMMs, SIMMs, and other memory units and memory chips well known to those skilled in the art and commercially available from numerous manufacturers such as Siemens, Toshiba, Texas Instruments and Micron. Other suitable devices for the memory unit and techniques for the use of encryption in the acquisition, storage and transmittal of data by or to the memory unit may be found in the commonly assigned United States Patent Applications incorporated herein by reference. In accordance with certain preferred embodiments at least one operative component mounted aboard the multi-layer laminated substrate, as disclosed above, is in communication with the microscale fluid flow channel and is operative to generate an electronic signal corresponding to a detected or measured fluid or characteristic of fluid in the microscale fluid flow channel, and the memory unit is connected to the operative component to receive and record the electronic signal. In preferred embodiments the fluid-handling device further comprises electronic communication devices, e.g. leads, wires or circuits, for communication with the memory unit. Suitable I/O devices for uploading signals to the memory component or downloading information stored on it will be readily apparent to those skilled in the art given the benefit of this disclosure, and include, for example, PCMCIA-type electronic communication ports, microprocessors, USB ports, serial ports, firewire ports, optical ports and the like. As stated above, preferred embodiments of the fluid handling devices disclosed here are operative to perform, or are adapted to function in a larger system which performs, any of various different liquid separation test or analysis methods. Liquid separation method parameters can be stored in a memory unit of the device or in a memory unit of the larger system and, in accordance with preferred embodiments, such information stored in the memory unit defines a liquid separation method such as, for example, liquid chromatography (LC), capillary electrophoresis (CE) or other liquid-phase separation techniques, e.g., micellular electrokinetic chromatography (MEKC or MECC), isoelectric focusing and isotachophoresis (ITP). For convenience, and not intending to limit the scope of the fluid handling device technology disclosed here, much of the following detailed description of certain preferred embodiments below will emphasize preferred embodiments that are operative to perform liquid chromatography.

In accordance with another aspect, components of the fluid-handling substrates, including, but not limited to, substrate layers and the interfaces of the substrate, such as inlet and outlet ports and component-on-board interfaces, are made of polyetheretherketone (PEEK). PEEK is a high temperature resistant thermoplastic. PEEK has superior chemical resistance allowing for its use in harsh chemical environments, and it retains its flexural and tensile properties at very high temperatures. Additionally, glass, carbon fibers, carbon black, carbon particles, gold, titanium dioxide, etc., may be added to PEEK to enhance its mechanical and thermal properties. One advantage of using PEEK in the assembly of a fluid-handling substrate is that a selective IR welding process may be visually monitored, as PEEK in its amorphous form can be a sufficiently clear and optionally colorless material. Therefore, fluid-tight seals within the multi-layer substrate, such as those created using selective IR welding discussed elsewhere herein or other suitable methods, for example, may be inspected prior to further assembly of the fluid-handling substrate. In accordance with certain preferred embodiments, crystalline PEEK is employed as a layer of the laminated substrate or a coating on another layer. Advantageously, crystalline PEEK provides good chemical resistance. In accordance with certain preferred embodiments, PEEK loaded with suitable IR absorber material, such as dyes for example, is coated onto the interface of two or more components, for example, the interface of the component-on-board and the substrate, to provide an additional measure for selectively welding the two components together to form a fluid-tight seal.

In accordance with other aspects, substrate assemblies are provided having selectively welded joint or interfacial areas between adjacent substrate layers, and having sealed channels incorporating environmentally sensitive elements, such as components embedded or housed within the channels or architectural micro-features. Exemplary embodiments include substrate assemblies incorporating architectural micro-structures or housing fluid analysis, testing or flow-control components which are not tolerant of the temperatures at which the adjacent substrate layers or components used to assemble the substrate would thermally weld together to from the fluid-tight microchannels. The elements are “not tolerant” in this context, in that the function or structure of the environmentally sensitive structure or element in question would be destroyed, impaired or undesirably altered by a thermal welding process in which substrate components are heated in bulk to the welding temperature. In certain embodiments, the environmentally sensitive element may not be disposed within the substrate but may be contained, or housed within, the external component-on-board, for example. It should be recognized that the term channel and microchannel as used here includes not only elongate voids or cavities within the body of the substrate assembly intended to carry a flow of fluid, but also chambers and other such configurations within the substrate.

In accordance with additional aspects, methods are provided for sealing together substrate components, e.g., plastic layers, to form the fluid-handling substrate without the need for adhesives, solvents, or exposure of environmentally sensitive elements of the substrate to the high temperatures, intense radiation, or pressures typically employed when thermally welding plastic assemblies. In accordance with certain preferred embodiments, a method is provided for producing the fluid-handling substrates disclosed immediately above, comprising substrate assemblies with internal fluid-tight sealed channels having environmentally sensitive elements. Such method comprises assembling together substrate components with an environmentally sensitive element incorporated in an internal channel, e.g., embedded or formed therein. The substrate components are then selectively welded together, preferably using IR radiation, to establish a fluid-tight seal along the periphery of the internal channel. Selective IR welding offers protection to the environmentally sensitive components because the substrate components are not heated in bulk to the welding temperature, thus the environmentally sensitive element incorporated therein is not heated to such temperature. In preferred embodiments, the bulk material of the substrate components adjacent to the location of the selective IR welding can act as a heat sink, thereby providing thermal protection to an environmentally sensitive element near the site of the selective welding. Thus, the method in accordance with this aspect enables the sealing of channels, such as micro-channels in fluid-handling substrates, without destroying the environmentally sensitive elements contained in the channels. The fluid-tight channels, in which environmentally sensitive elements can be incorporated without thermal damage, are especially advantageous in enabling fluid-handling substrates to be produced for use in a wide variety of applications including, for example, liquid chromatography and other fluid analysis, chemical and biochemical testing, detection and sensing and detection processes (in some cases referred to collectively below as fluid testing or as fluid analysis). It is also an advantage of at least certain embodiments, that fluid-tight sealing of the channels is accomplished without use of solvent or adhesive joining, thereby avoiding the problematic aspects of those methods discussed above.

In accordance with additional aspects, substrate assemblies are provided having selectively welded joint or interfacial areas between the substrate and an external component mounted to the substrate with a fluid-tight seal at a port in a surface of the substrate. Such external component (referred to in some instances here as a component-on-board), as disclosed above, can advantageously provide any of numerous functionalities to the fluid-handling substrate. For example, the component-on-board can act as a fluid reservoir, a detector, an analyzer, a separation conduit cartridge, or serve other roles. The component-on-board maybe permanently attached to the fluid-handling substrate or may be a removable component-on-board, which is referred to in some instances below as a swappable component-on-board. A swappable component-on-board provides for increased functionality of the fluid-handling substrate. For example, a first swappable component-on-board might be an apparatus for introducing a fluid into the fluid-handling substrate. After introduction of the fluid, the first swappable component-on-board might be replaced with a second swappable component-on-board, e.g. a detector, for analyzing the introduced fluid. The ability of a fluid-handling substrate to interface with multiple different types of external components expands the potential applications where a fluid-handling substrate may be employed.

In accordance with another aspect, a fluid-tight seal between the component-on-board and the substrate is formed by assembling the external component to the substrate (e.g., to a substrate component which can subsequently be joined with other substrate components), followed by selective welding to form the fluid-tight seal between them. Optionally one or more gaskets are used to provide an additional device for facilitating a fluid tight seal. An assembled fluid-handling substrate is provided that contains a port in communication with the surface of the substrate. The component-on-board communicates with the fluid-handling substrate and any internal channels and environmentally sensitive components within the substrate, through the port. The component-on-board is fixed to the substrate using any of numerous methods for attaching the components-on-board to the substrate, e.g. preferably selective IR welding is used. Selective IR welding at the interface of the port and the component-on-board can provide permanent attachment of the component-on-board to the substrate and create a fluid-tight seal at the port/component interface. Additionally, the selective IR welding of the component and the port prevents damage to any environmentally sensitive components contained within the fluid-handling substrate and prevents damage to sensitive components contained within the component-on-board.

In accordance with another aspect, a fluid-tight seal between a swappable (i.e., non-permanently mounted or removeable without damaging or destroying the rest of the substrate and/or the component-on-board itself) component-on-board and the substrate is formed by assembling the external component to the substrate (e.g., to a removable substrate component which can subsequently be joined with other substrate components), through one or more connectors on the port of the substrate and one or more connectors on the swappable component-on-board. An assembled fluid-handling substrate is provided that contains a port in communication with a surface of the substrate, e.g. any major or minor surface of the substrate. The port comprises one or more connectors for attachment to the swappable component-on-board, e.g. a female connector on the substrate that is operative to accept a component-on-board having a male connector. The swappable component-on-board communicates with the fluid-handling substrate, and any internal channels and environmentally sensitive components within the substrate, through the port. As discussed above, the swappable component-on-board may contain one or more connectors for interfacing to the fluid-handling substrate through the port. The connectors of the port and swappable component-on-board may be any connector known to those skilled in the art, such as a female connector on the port and a male connector on the swappable component-on-board, or vice versa. Upon connecting the swappable component-on-board to the port, a fluid-tight seal is created. Therefore, fluid communication can occur between the swappable component-on-board and any internal channels of the fluid-handling substrate without leakage of the fluid. This aspect is especially advantageous, since the amount of liquid introduced or contained within the fluid handling substrate might be very minimal, for example 15 microliters or less, and inadvertent loss of any fluid may result in reduced ability to detect species contained in the fluid.

In yet other aspects, the fluid handling devices disclosed above comprising a multi-layer laminated substrate are employed in combination with features and aspects of one or more others of them and/or other features and aspects suitable to a particular use or environment. In particular, exemplary of such other features and aspects, any or all of the following may be advantageously integrated into the fluid handling device. Electrical interconnections can be provided between components of the device and to an I/O port for data communication with an outside device. Surface interconnects, e.g., silk screened leads, soldering, conductive epoxies, wire bonding and tape assisted bonding, or 3D interconnects passing through the substrate can be used. Programmable controllers can be integrated into the fluid handling device to control heaters, pumps, sensors, memory chips, etc. Optical interconnections can be provided between components of the device and to an I/O port for data communication with an outside device. Optical interconnections can be provided via waveguides, fiber optics, free space IR transmissions, etc. Surface interconnects or interconnects passing through the substrate can be used. It will be within the ability of those skilled in the art to incorporate these and other components and functions into the fluid handling devices disclosed here, given the benefit of this disclosure.

### BRIEF DESCRIPTION OF THE FIGURES

Certain preferred embodiments will be described below with reference to the attached figures in which:

FIGS. 1A-1C show several configurations of a fluid-handling device or substrate. A first plastic piece 10 and a second plastic piece 11 have been welded together by selective IR irradiation of either the plastic pieces or by irradiation of an optional EM absorbing substance 12. The substrate 5 contains a channel 13 formed by welding of the two plastic pieces together. Optionally contained within the channel 13 is an environmentally sensitive element 14. The substrate 5 may also contain other channels formed from welding the plastic pieces together. For example, a second channel 15 is in close and continuous contact with an embedded microdevice 16. A port 17 provides communication from the channel to the top or bottom planar surface of the substrate. Additionally, an external device may be connected to the fluid-handling substrate through the port. An optional gasket 18 may be used to enhance the fluid-tight seal around the channel. An optional EM absorbing layer 19 may be placed anywhere along the surface of the substrate. In FIG. 1B, the multi-layer laminated substrate comprises three layers, preferably with a middle polymer layer. The outer layers may comprise fingers or projections into the middle layer to prevent any polymer creep, as shown in FIG. 1C.

FIGS. 2A-2D show several possible configurations for the channels formed from welding the plastic pieces together. Possible configurations include, but are not limited to, semi-circular 21, rectangular 22, rhomboid 23, and serpentine 24.

FIGS. 3A and 3B show one possible configuration for assembly of the fluid-handling substrate. The resulting channels and any internal components have been omitted for clarity. The welding of the plastic pieces is done first by aligning the planar surfaces of the plastic pieces 10 and 11 using a mechanical device, such as an alignment stage, as shown in FIG. 3A. In this embodiment, plastic piece 10 is capable of absorbing the incident radiation, whereas plastic piece 11 is energy transmissive. An EM beam 31 is applied through the surface of the transmissive plastic piece, as shown in FIG. 3B. Heating of the EM opaque plastic piece results in welding of the two plastic pieces together.

FIGS. 4A-4C show another possible configuration for assembly of a fluid-handling substrate. In this embodiment both plastic pieces 10 and 11 are EM transmissive. A coating of an EM absorbing substance 12 is first applied to the planar surface of one of the plastic pieces, as shown in FIG. 4A. The plastic pieces are then aligned using a mechanical device, as shown in FIG. 4B. An EM beam 31 is applied to the surface of one of the transmissive plastic pieces so that radiation is incident on the coating, as shown in FIG. 4C. Heating of the EM coating results in welding of the two plastic pieces together.

FIGS. 5A-5C show another possible configuration for assembly of the fluid-handling substrate where protecting an environmentally sensitive element 14 contained within a channel 13 is desired. The stacked plastic pieces 10 and 11 can be masked with an EM absorbing substance 19, as shown in FIG. 5A. The pieces may optionally be aligned, as shown in FIG. 5B. Only the unmasked portions are exposed to the EM beam 31 (see FIG. 5C) and, therefore, only those locations are heated to seal the plastic pieces. In this configuration, it is desirable to use a gasket to enhance the effectiveness of the fluid-tight seal.

FIG. 6 shows a fluid-handling substrate with a fixed external component. The external component 50 is mounted to the substrate through a port 17. The external component may comprise any external device including a detector, a computer, or other electrical or mechanical devices. The external component 50 is in liquid communication with an internal channel 13.

FIGS. 7A and 7B show a possible configuration for assembly of a fluid-handling substrate with a fixed component-on-board. In FIG. 7A, the component-on-board 50 is mounted to the assembled fluid-handling substrate 40. Selective IR welding using an EM beam 31 is then used to weld the component and the fluid-handling substrate together, as shown in FIG. 7B.

FIG. 8 shows a possible configuration for a fluid-handling device having a swappable component-on-board. The removable external component 60 comprises one or more connectors 65 for attachment to a fluid-handling substrate 40. The fluid-handling substrate 40 also has one or more connectors 66 for attaching to the component 60. Upon attachment of the component connector 65 to the fluid-handling substrate connector 66, a fluid tight seal is created. The swappable componenton-board may be in liquid communication with an internal cavity and any environmentally sensitive components contained therein.

FIG. 9 is an exploded view of a preferred embodiment, wherein an on-board operative component is mounted to a multi-layer laminated substrate via adhesive and gasket.

FIG. 10 is an exploded view of another preferred embodiment of the fluid handling substrates disclosed here.

FIGS. 11A and 11B together form a schematic diagram of a microfluidic substrate assembly i.e., a fluid analyzing device incorporating a microfluidic substrate assembly 130 (labeled as an “analytical cartridge”) in accordance with the invention, comprising a multi-layer laminated substrate.

FIG. 12 is a perspective view of a multi-layer laminated substrate in accordance with a preferred embodiment, shown in exploded view, partially broken away, with an on-board component and thermoplastic/electrical heater for mounting or seating the on-board component.

FIG. 13 is first embodiment of an analytical system in communication with a multi-layer laminated conduit cartridge, in accordance with preferred embodiments.

FIG. 14 is a multi-layer laminated manifold in fluid communication with a multi-layer laminated conduit cartridge, in accordance with preferred embodiments.

FIG. 15 is a multi-layer laminated manifold in fluid communication with a multi-layer laminated conduit cartridge and with a device for generating fluid flow, in accordance with preferred embodiments.

FIG. 16 is a second embodiment of an analytical system in communication with a multi-layer laminated conduit cartridge.

It will be recognized by those skilled in the art that the multi-layer laminated substrates shown in the figures are not necessarily to scale. The dimensions of the substrates may have been enlarged relative to the dimensions of an analytical instrument or a component-on-board, for example. Additionally, reference to orientation, e.g. top, bottom and the like, is for convenience purposes only and is not intended to limit the disclosure in any manner. One skilled in the art given the benefit of this disclosure will be able to select and design substrates having dimensions and geometries suitable for a desired use and suitable for use in any orientation.

### DETAILED DESCRIPTION OF CERTAIN PREFERRED EMBODIMENTS

Numerous embodiments of the present invention are possible and will be apparent to those skilled in the art given the benefit of this disclosure. The detailed description herein, for convenience, will focus on certain illustrative and exemplary embodiments. The multi-layer laminated substrates disclosed here, in embodiments operative to function in a liquid separation methods such as liquid chromatography (LC) or the like, will perform, or be adapted to be integrated into a fluid handling device which performs typical liquid separation steps, including but not limited to filtering, concentrating, separating and detecting, for example. A microchannel within the substrate may be packed with suitable media for chromatographic separations, e.g., HPLC separation. Removeably or permanently mounted components-on-board may carry and deliver solvent, buffers, reagents, etc. Filtering and concentrating can also be performed by the microfluidic substrate assembly. In certain preferred embodiments, the microfluidic substrate assembly may be cartridge-like, plugging into a larger fluid separation analysis device, e.g. an HPLC instrument, that performs many of these operations. In other embodiments, the microfluidic substrate itself can be considered as a component-on-board of another microfluidic substrate, e.g. a multi-layer laminated substrate conduit cartridge for example interfaced with a multi-layer laminated manifold attached to an analytical system. The microfluidic substrate assembly may be retained securely engaged in a receiving socket or the like in such larger fluid separation analysis device in various ways including, by way of example, a clamp or pressure plate mounted on the larger device, maintaining good surface-to-surface fluid-tight sealing between the confronting device surfaces, or by appropriate dimensioning the device relative to the receiving socket to frictionally retain the devices therein. Given the benefit of this disclosure, it will be within the ability of those skilled in the art to select operations, e.g., separation methods, sensors and other testing, to be integrated into the microfluidic substrate assemblies disclosed here, and to determine which operations, e.g., filtering, are to be performed by other devices. Cartridge-like embodiments intended for temporary use preferably are adapted to be inserted into a correspondingly configured socket or the like in a fluid analysis device. Fluid-tight fluid supply connections and any necessary electrical and electronic connections can be established in the socket by including a suitable electrical connector, e.g. PCMCIA connectors, on the substrate. It will be understood from the above, that excellent flexibility and a wide variation in the level of integration is provided by the technology disclosed here. Any fluid handling or processing steps not performed by the microfluidic substrate assembly is instead performed in accordance with well known technology by equipment associated with the cartridge. The following detailed discussion of certain preferred embodiments assumes, generally, that the microfluidic substrate assemblies are employed together with (i.e., connected to) suitable associated devices to perform any operations not performed by the microfluidic substrate assemblies, and that in preferred embodiments the microfluidic substrate assembly is received into a supporting socket in such device to establish fluid, electrical, electronic, optical and/or other connections called for by any particular application. The following discussion is also directed embodiments where the microfluidic substrate assemblies are used, either alone or in combination with other components, systems or instrument, to perform liquid chromatography methods. One skilled in the art given the benefit of this disclosure will be able to use the microfluidic substrate assemblies disclosed here for these and other uses.

It will be understood by those skilled in the art that the substrate assemblies disclosed here may comprise numerous different sizes and geometries, for example, the substrate assemblies maybe about 3½ inches by about 8½ inches, 3½ inches by 9½ inches, 3¼ inches by 4¾ inches, ⅝ inches by 1 inch, 4 inches by 6 inches, or the cartridge may have the dimensions of a postage stamp, a PCMCIA card, and a credit card. The different size cartridges have innumerable uses and may be used in any of numerous devices. For example, in embodiments that are 3½ inches by 9½ inches, the cartridge may be suitable for use as a pumping manifold, e.g. pump heads, degasser, flow meters, as injector manifolds, e.g. injector valves, pressure sensors, detector flow cells, and as pre-concentration manifold, e.g. flow-switching valves and pre-concentrators. In embodiments that are 3¼ inches by 4¾ inches, the substrate assemblies maybe useful as a screening manifold, e.g. reagent and sample flow switching valves, mixers, reactors and the like. In embodiments that are about the size of a PCMCIA card, the substrate assembles maybe useful as capillary electrophoresis cartridge, e.g. CE columns, as conductivity cells, as sensors, as valves, as pre-concentration cartridges, e.g. valves, pre-concentration units, sensors, etc., as dynamic field gradient focusing (DFGF) cartridge, e.g. DFGF units, valves, sensors, and the like. In embodiments that are ⅜ inches by 1 inch, the substrate assemblies may be useful as sensors chips, e.g. pH, PO₂, pCO₂, dissolved pO2, dissolved pCO₂, salinity, conductivity, nitrate and phosphate sensors, as mixer chips, e.g. active ultrasonic mixers, and may perform any unit operations required by a separation system or other analytical device. Additionally, the substrate assemblies may be stainless steel for high pressure, may have rigid side walls or integral ridges to prevent polymer creep, may fit into a bed of a robotic handler, e.g. a robotic fluid handler, may be plug and play, and may have numerous fluid and electrical connectors as discussed here.

It will also be understood by those skilled in the art that innumerable components-on-board may be chosen to provide additional functionality to the substrate assemblies disclosed here. For example, the component-on-board may be operative to induce flow in a microchannel of the multi-layer laminated substrate endosmotically or by electrochemical evolution of gases. The components-on-board may be operative as microfluidic devices, such as a fitting (e.g. tees, unions, bulkhead unions, expanders, reducers, etc.), a mixer (e.g. static, active, ultrasonic, etc.), a reactor (e.g. plug flow, stirred tank, packed bed, coated wall, etc.), an injector (e.g. a valve typically with a sample loop), a valve (e.g. rotary, sliding, spool, globe, gate, ball, diaphragm, etc.), a pump (e.g. diaphragm, piston, bellows, etc.), a compressor (e.g. centrifugal, bellows, piston, etc.), an ultrasonic bed (e.g. suspended particles, other combinations, etc.), an extractor (e.g. liquid-liquid, gas-liquid, gas-gas, solid-liquid, etc.), a pre-concentrator, a Dynamic Field Gradient Focusing (DFGF) device, may include one or more dialysis chambers, absorption chambers (e.g. a two chamber vessel with cells on separating support to monitor mass transfer), a metabolites chamber (e.g. for monitoring molecular changes), a toxicity chamber (e.g. for monitoring a response to toxins or the by-products of drug metabolism), and the like. The components-on-board may be operative as a detector, such as a UV/Visible absorbance flow cell, a fluorescence flow cell, a conductivity flow cell, an electrochemical detector (e.g. amperometric, cyclic voltammetry, etc.), a plasma detector, a mass spectrometry detector (e.g. electrospray MS source, quadrapole MS, particle beam MS source, glow-discharge MS source, chemical ionization MS source, plasma MS source, micro-Ion trap, electrospray plus micro-Ion trap, or time-of flight MS detector), and the like. The components-on-board may be operative as a sensor, such as a flow meter, a pressure transducer, a temperature sensor (e.g. thermocouple, resistance temperature detector (RTD)), a chemical sensor (e.g. pH, DO₂, DCO₂, salinity, conductivity, nitrate, phosphate, etc.) a capillary electrophoresis sensor, an acoustic sensor, a color sensor, an optical sensor, a bar code sensor, a photothermal sensor, a photoacoustic sensor, RFID tags, other Smart tags, and the like. The components-on-board may be operative to perform the function of numerous chemical devices and apparatus, such as reagent vessels, solvent degassers, separation columns (e.g. LC, CE, MEKC, etc.), iso-electric focusing columns (with or without ampholytes), size-exclusion columns, ion-exchange columns, affinity columns, solid-phase extraction beds and the like. The components-on-board may be operative as filters, such as a packed bed, sieves (e.g. molecular sieves), frits, depth filters (e.g. a channel stepped at increasing or—decreasing depths), a self-cleaning (e.g. back-flushed) filter, and the like. The components-on-board may be operative to perform innumerable other chemical and physical operations such as distillation, flash vaporization, to provide an orifice for a pressure drop, as cocurrent extraction or reaction beds, as countercurrent extraction or reaction beds, as heaters, heat exchangers, coolers, momentum separators, as magnetic field generators, as electric field generators, and the like. One skilled in the art given the benefit of this disclosure will be able to select these and other components-on-board for assembly to the substrate assemblies disclosed here.

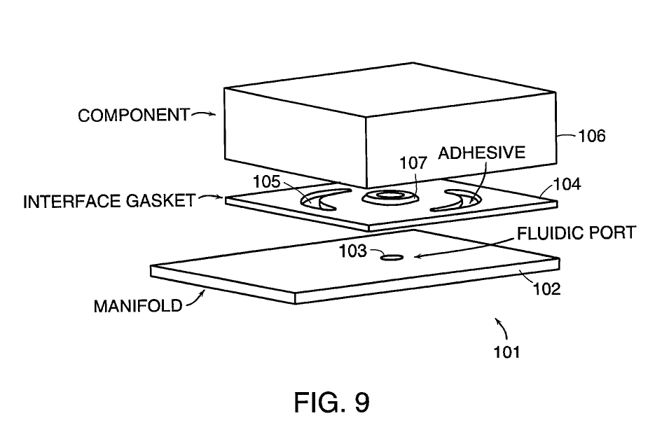

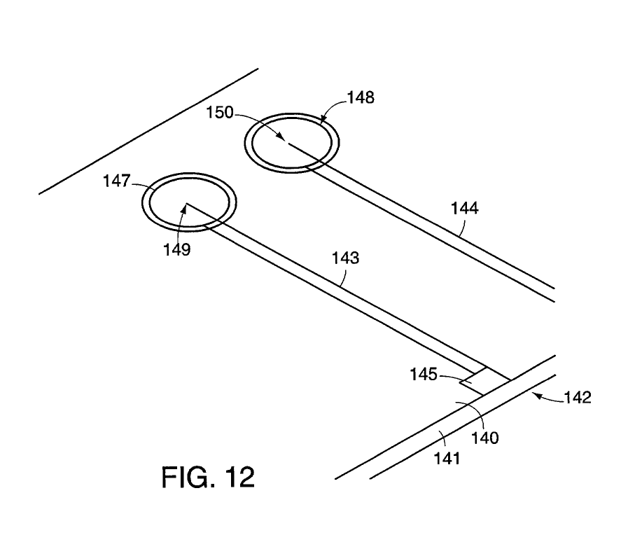

In accordance with certain preferred embodiments, as disclosed above, a microscale fluid flow channel is in fluid communication with at least one operative component mounted aboard the multi-layer laminated substrate. The on-board component can seat and seal to any surface of the substrate. In embodiments comprising plastic substrate layers sandwiched between steel, aluminum or other rigid plates, which are especially well suited for high pressure applications not previously thought appropriate for miniaturized fluid manifolds employing plastic components to define flow channels, the on-board component can seat and seal to an outside surface of one of the metal plates. Also, such components can seal to inner layers of the substrate through an outer sandwiching plate. Mounting and sealing can be accomplished using mechanical attachment devices, adhesives, gaskets and any combination of these and other mounting materials and techniques that will be apparent in view of this disclosure. For example, FIG. 9 shows an exploded view of a top plate 102 of a multi-layer laminated substrate 101 in accordance with the disclosure here. An on-board component 106 is shown prepared for mounting to the layer or plate 102 using an adhesive and gasket 104 having boss 107. The adhesive will bond to the gasket and to the top plate and component, in part through adhesive interface voids 105. Port 103 in the top plate will provide fluid communication between a correspondingly positioned port in the component (not shown) and a microchannel (not shown) in the substrate. The gasket boss 107 forms a seal around the port and insulates the adhesive from any adverse contact with the sample fluid. In certain preferred embodiments, thermoplastic materials are used as thermo-processed bonding interface materials. The thermoplastic PEEK has good adhesion properties to many of the materials found in commercially available operative components and provides good chemical and solvent inertness. The melt processing of a PEEK, or other thermoplastic bonding layer, preferably is controlled and localized to the fluidic junctions being formed. Light-activated adhesives can also be used such that the adhesive joins one or more layers after a suitable light source is incident on the adhesive. The light activated adhesive can be applied locally, e.g. to an area to be adhered, or can be applied to the entire surface of one or more layers. The bonding layer may also be required to maintain the geometry of the fluidic junction. Flow of the polymer during the melting stage is controlled to prevent closure of the junction. Thermal resistance welding can be used, for example, in conjunction with PEEK welded joints and can also be used to form the fluidic junctions between the substrates and on-board components. Suitable resistive elements for such thermal resistive welding can be defined accurately using thin or thick film technologies, and are capable of raising localized temperature to above the melting point of PEEK. Heat dissipation is also localized. These resistive elements are planar and can be readily coated with films of PEEK or other suitable thermoplastic. The material of the resistive element is chosen to provide good adhesion to the thermoplastic. Electrical activation of the resistive heater elements is readily performed in accordance with known techniques during typical mass production operations, and discussed further below in connection with FIG. 12. Electrical structures at the fluidic port preferably surround the port, and a layer of thermoplastic sufficient to establish the necessary seal is disposed onto the resistive heater in a pattern clear of the opening. The on-board component to be mounted to the substrate is accurately positioned, using mechanical devices such as an alignment stage, for example. The heater element is then activated to melt the thermoplastic. The component is pressed onto the substrate surface to establish intimate contact with the melted thermoplastic. The power to the heater element is then removed and the small quantity of heat generated during the mounting operation is dissipated into the component and the substrate and the thermoplastic interface solidifies to form the bond. FIG. 12 shows the outer surface 140 of a multi-layer laminated substrate 142 in accordance with the present invention. Surface electrical leads 143, 144 are seen to extend from heater electrical contacts 145, 146 to electrical resistive layers 147, 148 provided at fluidic ports 149, 150, respectively, on outer surface 140 of the substrate 142.

Thus, in a typical assembly operation, first and second components to be mounted to the multi-layer laminated substrate 142 are positioned at fluidic ports 149 and 150, respectively. Upon applying electrical energy to the leads 143, 144 through the heater electrical contacts 145, 146, the electrical resistive layers 147, 148 are heated sufficiently to locally melt or soften thermoplastic material surrounding ports 149, 150 and thereby to bond and seal the on-board component mounted at that location. One skilled in the art given the benefit of this disclosure will recognize that other devices and methods can be used to assemble the substrates and to assemble the components-on-board to the substrates, such as the methods discussed below.

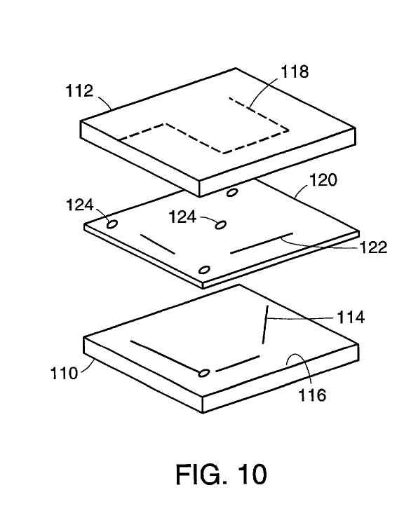

In accordance with certain preferred embodiments, an alternative approach employs an interface gasket, which preferably comprises conical fluidic connections somewhat similar to the ferrule type fluidic connections in conventional HPLC and the ferrule connectors described in the commonly assigned U.S Patent Applications incorporated herein by reference. Such features preferably are located on both surfaces of the gasket at the location of the fluidic junction of the on-board component and the substrate. During assembly, the component and the gasket are aligned onto the substrate and the gasket sandwiched under pressure between the component and the substrate. This forms a seal around the fluidic junction. Minimizing the area of contact between the gasket and the substrate or the component reduces the need for excessive localization pressures during component mounting. With the clamping pressure still in place, the position of the component can then be fixed by introducing an appropriate adhesive between the component and the substrate. Holes through the gasket would allow the adhesive to contact the component and substrate surfaces. After curing of the adhesive, clamping pressure can be removed. UV assisted curing resins allow shorter assembly processed time. (See discussion of FIG. 10.) A variety of techniques can be employed to provide electrical connections (for power and/or signal transmission) between an on-board component and the substrate, including sonic wire bonding, TAB bonding, solder or conductive epoxy bumps, z-access electrical interconnect materials, etc. Suitable alternative bonding and electrical interconnect materials and designs will be apparent to those skilled in the art given the benefit of this disclosure. The assembly process described above can optionally be automated, and many of the techniques are in use for SMT and flip-chip bonding operations. Suitable automated assembly operations will be apparent to those skilled in the art given the benefit of this disclosure.

In accordance with certain preferred embodiments, an operative component fixedly mounted to the laminated substrate is operative to pass fluid to or to receive fluid from a microchannel of the substrate. Such embodiments have application, for example, as highly advantageous microfluidic substrate assemblies for LC or other liquid separation devices, wherein the on-board component can serve as a reservoir for eluting solvents, buffers, reagents, etc. It will be understood from this disclosure, however, that communication between the microscale fluid flow channel and an operative component mounted aboard the multi-layer laminated substrate need not necessarily be fluid communication nor involve the flow of sample fluid between them or the discharge or injection of any liquid or other fluid from one to the other. On-board components in accordance with certain embodiments can comprise devices for generating fluid pressure in a microchannel of the substrate, such as the high pressure observed in HPLC systems or the like. Suitable devices will depend, in part, on the specific use intended for the microfluidic substrate assembly and include micro-embodiments of so-called wax motors also known as thermal actuators, heat capacitance motors or wax valve actuators. Such operative components generate pressure by the physical expansion of paraffin wax or the like as it changes from solid to liquid when heated within an enclosure such as a cylinder. The expanding wax is converted into mechanical force which causes translation of a piston slidably mounted within the cylinder, thus creating hydrostatic pressure. Such devices are known, although their use in microfluidic substrate assemblies as disclosed here has not heretofore been suggested or recognized. Exemplary such devices include those disclosed in U.S. Pat. No. 5,222,362, U.S. Pat. No. 5,263,323, U.S. Pat. No. 5,505,706, and U.S. Pat. No. 5,738,658, the entire disclosure of each of these patents being incorporated herein by reference for all purposes. The fluid communication between the substrate microchannel and such actuators or like components-on-board integrated with the multi-layer laminated substrate allows the fluid in the microchannel to be acted upon directly and physically. It will also be recognized from this disclosure, that in certain embodiments the operative component(s)-on-board integrated with the multi-layer laminated substrate may be in fluid communication so as to directly contact sample fluid or other liquid in the microchannel. Exemplary of such devices are impellant devices, for example, any of various micro-pumps, such as micromachined pumps, diaphragm pumps, syringe pumps, and volume occlusion pumps. Other suitable pumps include a piezoelectric-driven silicon micropump that is bubble and particle tolerant and capable of pumping liquids at 1 mL/min flow rates and commercially available from numerous sources such as FhG-IFT (Munich, Germany). Other pumping devices which can be employed as an operative component-on-board in various embodiments of the microfluidic substrate assemblies disclosed here include endosmotic induced flow devices, devices which pump by electrochemical evolution of gases and other pumping devices well known to those skilled in the art.

In accordance with certain preferred embodiments, other operative components suitable for mounting aboard the multi-layer laminated substrate will be apparent to those skilled in the art given the benefit of this disclosure, and will depend in most cases largely upon the application or use intended for the microfluidic substrate assembly. Exemplary of such other operative components are sensors for detecting or measuring a property or characteristic of fluid in the microchannel, or of a fraction or component of the fluid. Such sensors include, e.g., spectrographic sensors, such as sensors which comprise a light emitter passing light through a substantially transparent window or section of the microchannel and a light detector arranged opposite the emitter to receive and in some cases measure light. Such sensors and detectors, e.g. flow-cell detectors, are known although their use in microfluidic substrate assemblies as disclosed here has not heretofore been suggested or recognized. Other sensors may include, for example, silicon based miniaturized devices for electrochemiluminescent detection. The use of sensors as needed in microfluidic substrate assemblies disclosed here will be apparent to those skilled in the art given the benefit of this disclosure. Also exemplary of such other operative components which can be mounted to the laminated substrate are acoustic transducers and reflectors and the like. Here, again, such devices are known, but their use in microfluidic substrate assemblies as disclosed here has not heretofore been suggested or recognized. Acoustic components suitable for generating a standing wave ultrasonic field transverse to the direction of flow in a microchannel are disclosed, for example, in International Patent Application number PCT/GB99/023 84, the entire disclosure of which is incorporated herein by reference for all purposes. For example, such devices can be operative in certain embodiments of the microfluidic substrate assemblies disclosed here, when needed, to concentrate particles in fluid or to trap particles against a flow of suspending fluid. The above mentioned and other components which are generally commercially available provide the building blocks of integrated systems in accordance with the present disclosure, for performing simple or complex chemical analyses. Today micro-pump technology encompasses devices fabricated from a range of materials including polymers, and using methods that are mass fabrication compatible. Current pump prototypes deliver both liquids and gasses (including chemically aggressive fluids) at flow rates in the order of 1 mL/min or less, are bubble and particle tolerant and can self-prime. These pumps are now one component in an impressive array of devices that cover almost the entire spectrum of liquid handling requirements. This library of devices include but are not limited to mixers, filters, stream splitters, injectors, droplet ejectors, solid phase extractors, liquid/liquid exchangers, micro-reactors, micro-chambers, micro-valves and de-bubblers. For example, micro-nozzles fabricated in silicon for droplet formation and ejection can be used. In addition, there have also been some impressive developments resulting in flow meters capable of nanoliter precision, pressure sensors and temperature sensors. Micro-detectors also are available. For LC applications, several devices have been described. A few examples include electrochemical detection based on conductimetric, voltametric, redox, electrochemiluminescent, atomic emission and calorimetry detection principles. Other well known detection methods known to those skilled in the art may also be performed. In addition, miniaturized sensors with active sensing areas of a few microns can also be envisioned as detectors for LC applications.

In accordance with certain preferred embodiments, the fluidic connections present between the substrate (which can be viewed as and may be referred to as a manifold) and the various operative components typically fall into two main categories:

1. Critical connections requiring zero dead volume and optimized flow characteristics.

2. Non-critical connections that do not require zero-dead volume interfaces or optimized flow-through characteristics.

These fluidic connections preferably allow the assembly of a variety of components that may not be designed specifically for the substrate. In many cases components may be provided that have a flat surface that can mate with the substrate, and holes in this surface that provide the fluidic connection. Other components may require alteration to allow compatibility with the substrate. Alterations involving adding adaptor structures that convert the native format of the device to the format required by the substrate. Alternatively, a redesign of the component may also be possible and most cost effective.

In accordance with certain preferred embodiments, it will be understood that the multi-layer laminated substrates disclosed here are fluid-handling devices or components of fluid handling devices, in which layers are assembled into a laminated structure to define fluid microchannels and typically additional features. The two or more layers are stacked one on another with surface-to-surface bonding at their major (i.e., large) surfaces, e.g., by thermal welding, solvent welding, thermal resistance welding, focused or unfocused IR welding, adhesives, etc. If adjacent substrate layers to be joined have dissimilar thermal conductions (e.g., silicon and PEEK), then thermal bonding of these layers may be suitably accomplished by methods not requiring the heating of the entire mass. Heat can be introduced to the interface by applying it to the high thermal conduction material. The stacked layers preferably are substantially co-planar, optionally being curvo-planar or having other configuration, with one or more microchannels of the laminated substrate being formed at the surface-to-surface interface of adjacent layers, such that the bonding of the layers to each other forms the closed cross-section of the microchannel, i.e., forms a fluid-tight seal along at least a major portion of the longitudinal run of the channel.

In accordance with certain preferred embodiments, the fluid handling devices disclosed here may be conveniently constructed by forming the flow passages in the surface of a suitable substrate layer, such as a layer of flexible or rigid plastic or other material, and then laminating the adjacent layer to the first layer. Micromachining technology is known, which is suitable for the manufacture of at least certain embodiments or certain portions of the microfluidic substrate assemblies disclosed here, having elements with minute dimensions, ranging from tens of microns to nanometers. A portion of one or more substrate microchannels may be formed in one or more of the substrate layers, such that the complete channel is only formed when the layers are joined together. The pieces are joined together in a fluid-tight manner to seal the channel, e.g., to form a closed (i.e., fluid-tight) periphery for the channel, such as for the transport of fluids. Closing or welding the pieces together to form and seal the channels can be accomplished in a number of known ways. One such method involves assembling, i.e., positioning the pieces together and heating the assembly to the melting point, or at least the softening point, of one or both of the pieces (or all of the pieces where more than two pieces are assembled together). Adhesive methods also are known for assembling the miniaturized fluid-handling substrates. Other methods will be readily apparent to those skilled in the art given the benefit of this disclosure.

In accordance with certain preferred embodiments, microfluidic substrate assemblies disclosed here, having a multi-layer laminated substrate, can be designed and fabricated in large quantities using known micromachining methods. Such methods include film deposition processes, such as spin coating and chemical vapor deposition, laser machining or photolithographic techniques, e.g. UV or X-ray processes, etching methods, e.g. deep reactive ion etching, which may be performed by either wet chemical processes or plasma processes, LIGA processing and plastic molding. See, for example, Manz et al., Trends in Analytical Chemistry 10:144-149 (1991), the disclosure of which is incorporated herein by reference. More generally, the design and construction of microfluidic substrate assemblies disclosed here can commence with computer aided design of the device. Optionally, rapid prototyping of the device can be performed, e.g., using laser machining and micro-milling to quickly produce small quantities. Production quantities are advantageously produced using LIGA and electroforming techniques to produce a master, such as a nickel metal master or a suitable die for receiving materials. The master can be used in the production of relatively large numbers of units through injection molding and embossing techniques. Finished devices typically will require additional production steps, such as coating, packing and filling steps in accordance with known manufacturing techniques.

In accordance with certain preferred embodiments selective welding is accomplished by IR radiation. The substrate formed in this way has one or more internal fluid channels, and may be essentially planar or block-like in configuration. Also, the substrate assembly may be welded or otherwise joined to other pieces or components, such as to form a cartridge to be inserted into a corresponding socket or port to form fluid-tight seals with fluid lines communicating with a process line carrying fluid to be analyzed or detected or the like. The selective welding of substrate pieces together, e.g., two or more planar plastic pieces to be stacked together and selectively welded to form seals establishing fluid-tight channels within the resulting body, utilizes IR radiation, laser or the like, on the areas of the plastic pieces to be joined. This process is usually done by positioning two substrate pieces in direct and continuous contact with one another and subsequently exposing the pieces to radiation.

Taking a preferred embodiment of plastic substrate layers to illustrate this aspect, one of the plastic or other material pieces may be transparent to the radiation while the other is opaque to radiation. Alternatively a radiation absorbing material can be dispersed within one of the plastic pieces, either selectively in the area to be welded or throughout the body of the material forming the piece. Alternatively a radiation absorbing material can be coated on the surface of one or both of the pieces, either selectively in the area to be welded or all over. Where selective absorption is not established, the use of focused or masked radiation or the like can be used to accomplish the selective welding. It should be recognized that selective welding of an interface between two substrate pieces assembled together may in some embodiments include irradiation and welding of the entire interface. The disadvantages discussed above of thermal welding are still avoided, since it is not necessary to heat the substrate assembly in its entirety to the melting or welding temperature. It is the joint region or interface of the two plastic pieces that is exposed to radiation, forming the selective weld. Again using plastic substrate pieces to illustrate this aspect, the radiation from a laser beam or other radiation source can pass through a transparent plastic piece and into an opaque plastic piece. Melting of the opaque plastic piece results as the incident radiation is absorbed by the opaque plastic piece. Removal of the radiation results in cooling and formation of a weld between the two plastic pieces.

In published PCT application No. WO 00/20157, the entire disclosure of which is incorporated herein by reference for all purposes, a method of forming a weld between two workpieces is taught, one of the pieces being opaque and the other being transparent to radiation. It also teaches a method of providing a radiation absorbing material at the joint region of the two workpieces, where both plastic pieces are transparent, in order to form a weld between them. Infrared radiation (IR) bonding has been used to join plastic articles, as in U.S. Pat. No. 6,054,072, the entire disclosure of which is incorporated herein by reference for all purposes. The use of such techniques in the methods disclosed here and the advantages in the methods disclosed here will be apparent to those skilled in the art given the benefit of this disclosure.

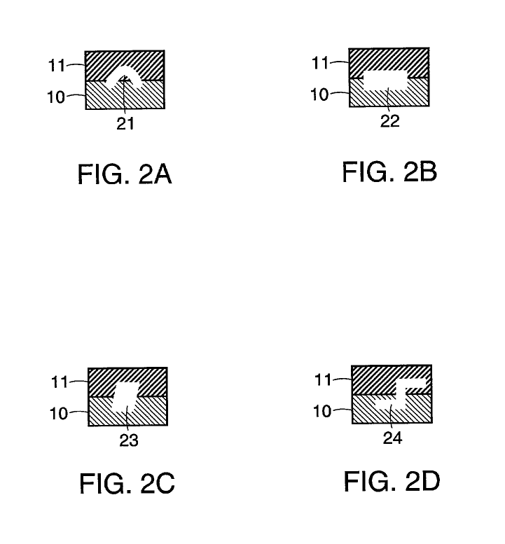

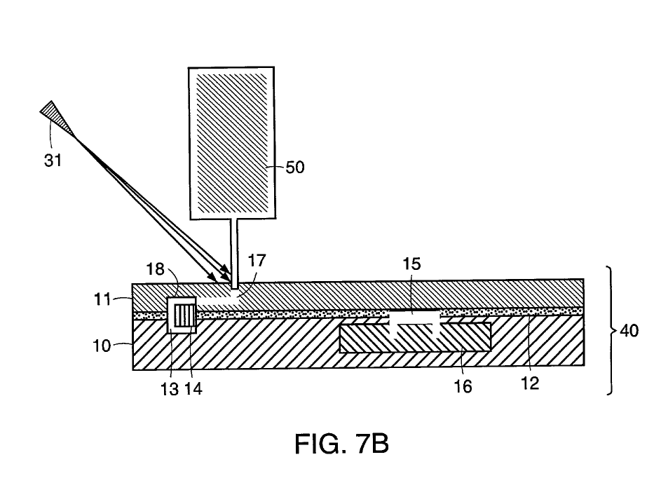

In accordance with certain preferred embodiments, FIG. 7A shows a cross-sectional view of an exemplary configuration of a fluid-handling substrate 5. The top planar surface, hereafter referred to as the major surface, of a first plastic piece 10 and a major surface of a second plastic piece 11 have been welded together by irradiation of either the plastic pieces or of an optional EM absorbing substance 12 or both. The plastic components of the fluid-handling substrate described herein are preferably made of, but not limited to, materials selected from the group consisting of polysulphone, PEEK, polyfluoroethylene (PFE), polycarbonate, ceramic, Teflon, stainless steel, polydimethylsiloxane (PDMS), pyrex, soda glass, CVD diamond, PZT, silicon nitride, silicon dioxide, silicon, polysilicon, Au, Ag, Pt, ITO, Al, and combinations of any of them. PEEK is a preferred material for the plastic pieces and components to be made from because it is chemically inert, is insoluble in most common solvents, and it is also resistant to attack by a wide range of organic and inorganic chemicals. PEEK has excellent flexural, impact, and tensile characteristics. PEEK is especially advantageous because it has a low glass transition temperature (Tg) and will weld at a temperature that will not lead to the distortion, warping, or destruction of environmentally sensitive elements contained within the plastic pieces. Additionally, PEEK allows for visualization during the welding process and for visual inspection of the seals created by the welding process. One or more additives may be included in the materials used in the fluid-handling substrates. For example, the additives may impart a desired color or other optical property to the fluid-handling substrate or may add strength to the materials such that the fluid handling substrate can be operated at higher pressures. For example, materials such as fibers, polymers, powders, carbon fill, carbon black, fiberglass, plastic and metal fibers, can be added to PEEK to provide increased strength, e.g. increased strength such that the fluid handling substrate may be operated at pressure above about 10,000 psi. The substrate contains a channel 13 formed by welding of the two plastic pieces together. The cavities or chambers within the plastic pieces that form the channels (after the plastic pieces are welded together) can be formed into the plastic pieces using any method known in the art including, but not limited to, UV-embossing, heat-embossing, laser ablation, injection molding, CNC micro-milling, silicon micro-machining, focused ion beam machining, wet etching, and dry etching. The channels can be of a large variety of configurations. For example, referring to FIGS. 2A-2D, a wide variety of channel geometries including, but not limited to, semi-circular 21, rectangular 22, rhomboid 23, and serpentine 24 can be formed in the fluid handling substrates. The channels maybe one dimensional or multidimensional (two-dimensional or-three dimensional). As used herein, the term one dimensional channel means a channel that runs along a single axis aligned with the plane of the substrate. The term multidimensional channel, as used herein, means a channel that runs along two or more axes, perpendicular to each other, in the plane of the substrate. The resulting dimensional aspects and architecture of the channels are especially sensitive to high temperature conditions because they can warp to the point at which they would no longer be functional or maintain the desired shape or configuration. One skilled in the art given the benefit of this disclosure will be able to choose and design channel configurations suitable for incorporation into the fluid handling substrates disclosed here.

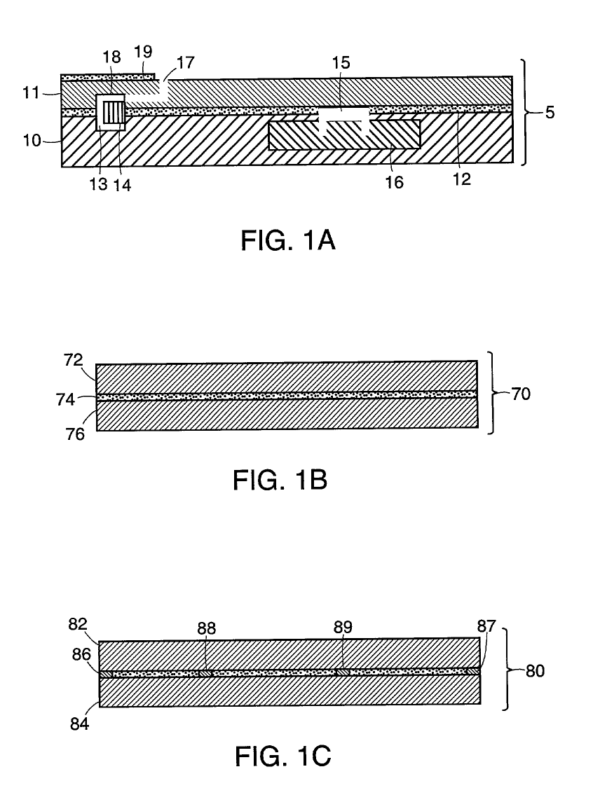

In accordance with certain preferred embodiments, referring again to FIG. 1A, optionally contained within the channel 13 is an environmentally sensitive element 14. As used herein, the term “environmentally sensitive element” refers to elements that would be destroyed if they were subjected to temperatures normally required to seal the plastic pieces and/or were exposed to one or more fluids, e.g. strong acids, that might damage the element. Therefore, what is considered environmentally sensitive depends on the substrate material being welded, the temperatures and or pressure used during the welding, and on the species in a fluid that is introduced into the fluid handling substrate. Environmentally sensitive elements, as used here include, but are not limited to, the architecture of the channels, fluids, soft gaskets, polyelectrolyte and other gels with valving sub-systems, flexible membranes, sensors with tiered membrane assemblages, electrical sensors, mechanical devices, biological components with sensor membranes, reagents for biotransformations, arrays of gene probes and analogues, detectors, and chromatography reagents. Certain sensors, whether electrical or biological, are also sensitive to high temperature and tend to be destroyed by the high temperatures. Fluids can also be sensitive to chemical adhesives and high temperatures of the current welding methods, and the composition of any adhesives added to effect welding of the pieces together may be altered by the incident radiation, for example the adhesive may photoreact with the other components within plastic pieces. Some fluids are susceptible to chemical reactions under high temperature and pressure, and the resulting products could change the character and reactivity of the fluid. For example, chromatography reagents, such as beads with bonded phases, can be destroyed by high temperatures. The substrate may also contain additional channels formed from welding the plastic pieces together. For example, referring to FIG. 1A a second channel 15 is in close and continuous contact with an embedded microdevice 16. One skilled in the art given the benefit of this disclosure will be able to design fluid handling substrates comprising a plurality of channels and innumerable environmentally sensitive elements.

In certain preferred embodiments, a microchannel is formed in the multi-layer laminated substrate at the interface of two layers. It is an advantageous aspect of these preferred embodiments that the layers are effectively welded or otherwise joined to form a fluid-tight seal along the periphery of the channel. A fluid-tight seal is a seal in which the channels do not leak fluid. That is, substantially no fluid can enter or exit the channels through the sealed periphery, but rather only through fluid communication ports provided in the substrate. For example, referring to FIG. 1A, port 17 is seen to comprise an opening in the surface of the fluid-handling substrate. It will be understood from this disclosure, that such fluid ports can be positioned at any convenient location in the surface of the substrate, taking in to account the need to provide fluid channels within the substrate to the port. The port may be located on either a major surface or on any side surface, hereafter referred to as a minor surface, of the substrate. Port 17 can be in communication with an internal microchannel that can extend to or through plastic layer 10 and/or 11 of the substrate. An element 14 is contained within channel or chamber 13 and is in fluid communication with port 17 of the substrate. An embedded microdevice 16 is contained within a second channel or chamber 15. It can be seen that both fluid channels 13 and 15 are formed by and at the interface of the two substrate layers 10, 11. The port and microchannel can be any suitable configuration, such as, straight, serpentine, spiral etc.

Also, a wide variety of port geometries including, but not limited to, semi-circular, rectangular, and rhomboid can be formed and are limited only by the thickness of the materials forming the fluid-handling substrate. Additionally, one or more additional microchannels may connect channel 17 and channel 15 such that fluid can flow between the two channels. In certain embodiments a valve may be embedded in a third channel (not shown) that is operative to connect channel 17 and channel 15. The valve can be opened to provide for fluid flow between the two channels or the valve can be closed to prohibit fluid flow between the channels. Such interconnected channels may be useful where, for example, the fluid handling substrate comprises multiple sensors in different channels and the valve is operative to direct the fluid to only one of the sensors. As discussed below, the port may in certain preferred embodiments be employed as a docking site for a component-on-board, e.g., an external device mounted to the substrate for increased functionality, more specifically, a mounted component that will be in fluid communication with a microchannel in the substrate. A gasket 18 may be used to form or enhance a fluid-tight seal between a mounted component-on-board and the surface of the substrate. A gasket, as referred to herein, may be an O-ring carried by the mounted component or by suitable structure of the substrate. In certain preferred embodiments, curable gaskets are employed at the mounting site of a component-on-board. Such gaskets can be usefully formed of radiation absorbing materials, such as plastics or metals, and preferably have a lower Tg than the adjacent materials of the substrate and on-board component. After the component is positioned on the substrate the gasket at the joint between them is subjected to actinic or curing radiation. Also, suitable gaskets, e.g. PEEK gaskets, can be microformed on or in the surface of the laminated substrate and/or the surface of the component to be mounted. A gasket can also be employed that covers the entire contact surface of the substrate and the component. One skilled in the art given the benefit of this disclosure will be able to design suitable gaskets for sealing the fluid handling substrates described here.

In accordance with certain preferred embodiments, the fluid-handling devices disclosed here may comprise a plurality of layers with different materials being used in the different layers. For example, referring to FIG. 1B, a fluid handling substrate 70 may comprise a first layer 76, a second layer 74 and a third layer 72, in which the second layer 74 is disposed on the first layer 76 and the third layer 72 is disposed on the second layer 74. Preferably the first layer 72 and the third layer 76 are manufactured from steel or other materials capable of withstanding high pressures. Preferably the middle layer is manufactured from a polymer, such as PEEK. The second layer can be disposed, e.g. coated, deposited and the like, in accordance with the methods described here and with other methods known to those skilled in the art. In especially preferred embodiments, where the fluid-handling devices are operative at extremely high pressures, e.g. greater than 10,000 psi, more preferably greater than 15,000 psi, the first and third layers may contain projections, e.g. upward or outward projections, to reinforce the fluid-handling devices. For example, referring to FIG. 1C, a multi-layer laminated fluid-handling device 80 comprises a first layer 84 having upward projections 86 and 87 that contact the third layer 82 such that the second layer is completely enclosed in the fluid-handling device. That is, no surfaces of the second layer are exposed to the outside, except through a port extending from the surface of the fluid-handling device into the second layer, for example. Upward projections 86 and 87 may comprise any of numerous forms including for example reinforcing sidewalls, reinforcing members and the like. Optionally, additional projections, or mechanical barriers, 88 and 89 may extend between the first and third layers and into the second layer to further reinforce the fluid-handling device. In embodiments comprising upward projections that are operative to reinforce the fluid handling device, the device may be assembled using any of the methods discussed above including for example, adhesives, welding and the like. One skilled in the art given the benefit of this disclosure will be able to design suitable fluid-handling devices capable of operating at extremely high pressures, in accordance with the devices and methods described here.

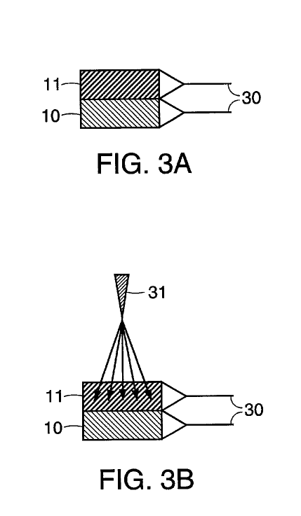

In accordance with certain preferred embodiments, assembly of the fluid-handling substrate occurs as the substrate pieces are welded together and the channels are preferably sealed using selective EM welding techniques, such as selective IR welding. Selectively welded, as used herein, refers to a weld that produces a fluid-tight seal surrounding the channels in the plastic pieces or components of the fluid-handling substrate. The selective welding is preferably done substantially in the area immediately surrounding the channel the weld is intended to seal. However, this does not exclude any welding location that may create a fluid-tight seal. The most preferable welding methods include, but are not limited to, IR dosage (pulsed, continuous, intensity, frequency/bandwidth), IR delivery (spot, flood), thermal conditions (workpiece, platen(s), pick tools), ultrasonic agitation, or pressure. For illustrative purposes only, FIGS. 3A and 3B show one possible configuration for assembly of a fluid-handling substrate that contains an environmentally sensitive component. The resultant channels and any components contained therein have been omitted from FIGS. 3A and 3B for clarity. The chambers or cavities responsible for forming the channel after the pieces have been welded together can be machined into the plastic pieces using any method known to those skilled in the art, such as those described above. Referring to FIG. 3A, a first plastic piece 10 is capable of absorbing the incident radiation, whereas a second plastic piece 11 is energy transmissive. The welding of the plastic pieces is done by first aligning the major surface of the first plastic piece 10 and the major surface of the second plastic piece 11 using a mechanical device 30, such as a clamp or an alignment stage or a clamp on an alignment stage, for example. Next, radiation, preferably in the form of EM beam 31, is applied through the surface of the transmissive plastic piece (see FIG. 3B). The EM opaque first plastic piece will absorb the energy of the EM, and heat will be generated causing the surface of the plastic pieces to melt or soften. The melted surface will cool, and the plastic pieces will then be welded forming a channel with a fluid-tight seal. One skilled in the art given the benefit of this disclosure will be able to use these and other techniques for assembling the layers of the fluid handling substrates described here.

In accordance with preferred embodiments, the plastic pieces and gaskets are preferably made of PEEK as this material provides for the possibility of visual or optical inspection of the weld and resultant fluid-tight seal. Additionally, other properties of PEEK make its use desirable. PEEK has superior chemical resistance allowing for its use in harsh chemical environments. PEEK retains its flexural and tensile properties at very high temperatures. Additionally, glass and carbon fibers, or other materials, may be added to PEEK to enhance its mechanical and thermal properties. One advantage of using PEEK in the assembly of a fluid-handling substrate, as discussed above, is that the selective IR welding process may be visually or optically monitored, as PEEK is a clear and colorless material. Therefore, the fluid-tight seals that are created, using the selective IR welding process, may be visually or optically inspected prior to further assembly or distribution of the fluid-handling substrate. If upon visual or optical inspection it is determined that the seal is not a fluid-tight seal, additional selective welding can be performed prior to testing of the fluid-handling substrate, thus the quality of the assembled fluid-handling substrates and the integrity of the fluid-tight seals is much improved compared to other prior devices. One skilled in the art given the benefit of this disclosure will be able to assemble PEEK layers into the fluid handling substrates disclosed here.

In accordance with certain preferred embodiments, joining of plastic pieces and sealing of channels can be accomplished with a focusable EM beam, such as a laser. As used herein, the term focusable EM beam refers to any light source where the size of the light incident on the surface is very small when compared to the overall size of the surface, whereas an EM beam refers to any light source that may illuminate a significant portion or all of a surface. An advantage of using a focusable beam includes direction of the radiation away from any areas that might be damaged from the radiation, such as those areas containing an environmentally sensitive element, for example. Thus by using the focusable EM beam, a fluid-tight seal may be created without risking damage to any environmentally sensitive element within or attached to the fluid-handling substrates. The focusable beam may also be coupled with the use of a dye for time scheduled selective welding. As used herein, time scheduled selective welding refers to using different dyes between or coated on or contained within different portions of, each layer of the fluid-handling substrate. Two or more dyes can be used to ensure only those areas containing the appropriate dye are welded together. For example, two dyes, Epolight 5010 and Epolight 6084, both from Epolin, Inc. (Newark, N.J.), are coated independently on different portions of the fluid-handling substrate to be assembled. Epolight 5010 has a maximum light absorption at about 450 nm while Epolight 2057 has a maximum absorption at about 1064 nm. Therefore, radiation having a wavelength of 1064 nm, such as an infrared laser, would only be absorbed by the Epolight 2057, and only the areas of the fluid-handling substrate containing the Epolight 2057 would be welded together. A different radiation source having a wavelength of about 450 nm, such as an argon laser, would be required to weld any areas containing the Epolight 5010. One skilled in the art, given the benefit of this disclosure, will recognize that a focusable EM beam could be used in combination with multiple dyes for time selective welding and increased protection of environmentally sensitive elements. Additionally, a tunable dye laser could be used to provide rapid switching of the incident wavelength and thus providing more rapid methods for the selective welding process and assembly of the fluid-handling substrate. Additional materials suitable for use as IR absorbing materials include high temperature dyes, also available from Epolin, Inc., such as Epolight 3079, Epolight 4049, Epolight 3036, Epolight 4129, Epolight 3138, and Epolight 3079, for example. One skilled in the art given the benefit of this disclosure will be able to use these dyes and other dyes and materials for selectively welding layers to form the fluid handling substrates described here.

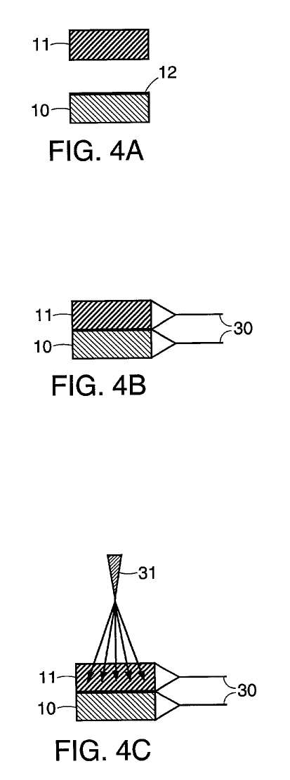

In accordance with certain preferred embodiments, if all the pieces of the substrates are EM transmissive, the pieces maybe coated with a substance that is EM opaque such that selective welding of the layers can be performed. The EM absorbing substance may be any substance capable of absorbing the incident radiation. Preferred EM absorbing substances include, but are not limited to, dyes and pigments, for example, Epolight 5010, Epolight 5532, Epolight 6034, and Epolight 1125, all from Epolight, Inc., (Newark, N.J.). FIGS. 4A-4C show an exemplary configuration for assembly of a fluid-handling substrate where all layers of the substrate are EM transmissive. When joining plastic pieces that are all EM transmissive, it is necessary to either coat the surface of one or more of the plastic pieces with an EM absorbing substance to form an EM absorbing layer 12 or incorporate an EM absorbing substance into at least one of the plastic pieces. EM interfaces, composed of any EM absorbing substance such as dyes or dye-containing substances, can be created by contrasting administration regimes including, but not limited to, spin-coating, micro-dispensing, and micro-contact transfer printing and the like. Referring to FIG. 4A, a coating of an EM substance 12 may be first applied to a major surface of the first or second plastic piece or both. The plastic pieces 10 and 11 may then be aligned using a mechanical device 30, such as an alignment stage, for example (See FIG. 4B). An EM beam 31 is applied through the surface of one of the transmissive plastic pieces so that radiation is incident on the EM absorbing coating 12 (see FIG. 4C). Heating and subsequent cooling of the EM coating results in welding of the two plastic pieces together, and formation of a channel with a fluid-tight seal. A gasket may be used to further enhance the effectiveness of the fluid tight seal. One skilled in the art given the benefit of this disclosure will be able to select suitable EM absorbing materials for assembly of the fluid handling substrates disclosed here.

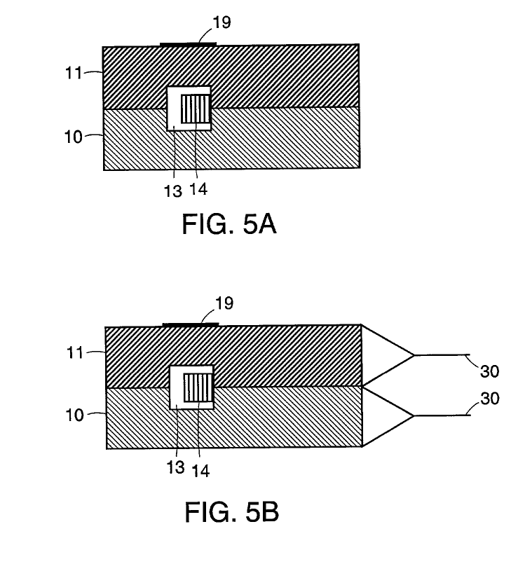

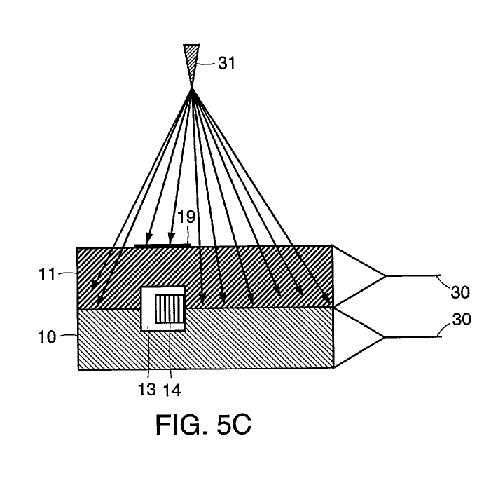

In accordance with certain preferred embodiments, a method for assembly of a fluid-handling substrate comprising environmentally sensitive elements, as discussed above, is disclosed. Referring to FIG. 5A, for additional protection of the environmentally sensitive elements, the stacked layers can be masked with an EM absorbing substance 19 and only the unmasked portions are exposed to the EM radiation and, therefore, only those locations are heated to seal the layers. The use of blocking materials confers spatially and/or temporally selective protection/deprotection of the environmentally sensitive elements in the channels from the EM radiation. These methods prevent the environmentally sensitive element from becoming heated and subsequently destroyed by the heat from the sealing process. A gasket may be placed around the resulting channel and acts to increase the effectiveness of the fluid-tight seal and to dissipate any surrounding heat that could potentially damage the environmentally sensitive element. If a focusable EM beam is used, as discussed above, the aligned layers can be moved in relation to the EM beam to facilitate joining of the correct positions on the plastic pieces. Alternatively, the beam can be moved in relation to the aligned plastic pieces. These two methods allow for greater control over the portions of the fluid-handling substrates that are irradiated, heated, and sealed. After suitable alignment of the pieces (see FIG. 5B), the pieces can be welded together, as shown in FIG. 5C, without damaging any environmentally sensitive elements contained within the fluid handling substrate. One skilled in the art given the benefit of this disclosure will be able to dispose suitable masking layers for assembly of the fluid handling substrates without damage to any environmentally sensitive elements contained therein.

In accordance with preferred embodiments, the radiation necessary to weld the plastic pieces together may be administered using several different methodologies including, but not limited to, fibre delivery, controlled spot size and controlled spot intensity, seam forming, and large area rastering. Preferred joining methodologies for the plastic pieces and/or components include IR dosage, IR delivery, thermal conditions, ultrasonic agitation, and pressure. The EM radiation source may be any type of EM source, including commercially available lamps, e.g. arc lamps, or lasers. The EM radiation most preferable is infrared radiation (IR) with the IR source preferably being infrared lasers or infrared heat bulbs having tungsten filaments and integral parabolic reflectors. The EM source may optionally include lenses that vary the focal point of the beam. The EM source is generally positioned and tuned to project the EM beam a lens or grating and onto the aligned and mated layers of the fluid-handling substrate. It will however, be realized that any EM source, and any necessary accessory optical components, e.g. lenses, gratings, filters, monochromators and the like, may be used provided that a suitable EM absorbing material is available, and, if appropriate, one plastic piece is transmissive to the EM radiation used. One skilled in the art given the benefit of this disclosure will be able to select suitable radiative sources and methods for focusing those radiative sources onto layers to form fluid-handling substrates having fluid-tight seals.

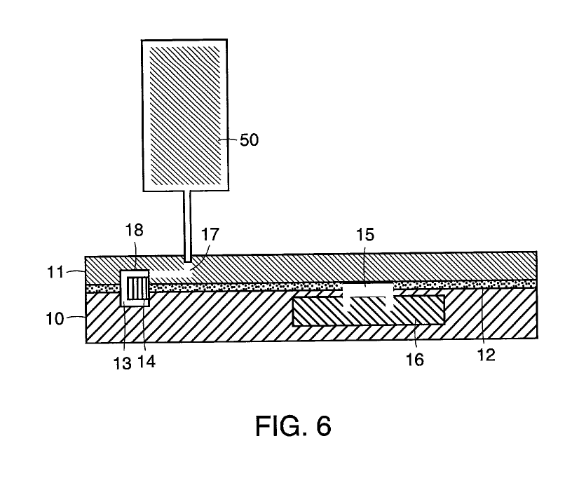

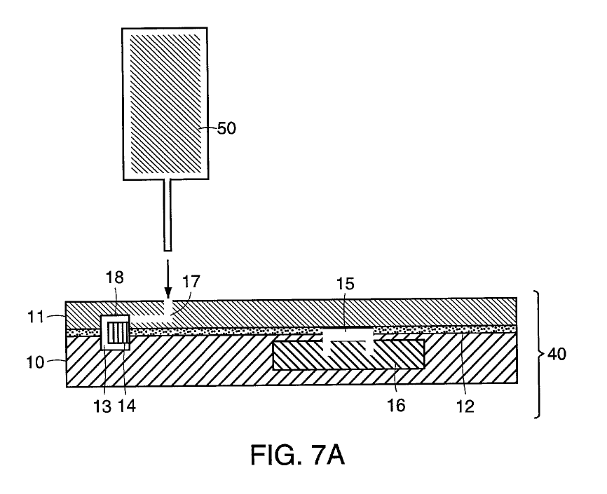

In accordance with certain preferred embodiments, the fluid-handling substrate may comprise an external component attached to the assembled fluid-handling substrate. Such external component, which is referred to as a component-on-board, can advantageously provide any of numerous functionalities to the fluid-handling substrate. For example, the component-on-board can act as a fluid reservoir, as an analytical device, such as a conduit cartridge, as a data analysis system, such as a computer, as a delivery device or may serve other roles. For illustrative purposes only, FIG. 6 shows an embodiment of a fluid-handling substrate containing an attached component-on-board. The fluid-handling substrate may be assembled using any technique described above or any technique known to those skilled in the art. For example, the interface of the component-on-board and the fluid-handling substrate may be selectively welded such that a fluid-tight seal is created between the external component and the fluid handling substrate. A component-on-board 50 is attached to a port 17 on the surface of the substrate assembly. As discussed above, an optional gasket may be used at the interface of the port and the component-on-board to provide for a more effective fluid-tight seal between the component and the fluid-handling substrate. An internal fluid-tight sealed channel 13 may be in fluid communication with the attached component. Innumerable other devices may be disposed within the fluid handling substrate and/or the component-on-board. For example, the component on-board may comprise one more detectors. In especially preferred embodiments, the component-on-board is a conduit cartridge that is operative to separate species in a fluid. Suitable conduit cartridges are disclosed in the commonly assigned U.S. Patent Applications that have been incorporated herein by reference for all purposes. In other embodiments, as described in Examples 1 and 2 below, the fluid handling substrate is interfaced with an analytical system and also with a conduit cartridge. Thus fluid maybe introduced into the fluid handling substrate 5, from a solvent reservoir in the analytical system for example, the fluid can traverse the microfluidic channels of the fluid handling substrate and can enter a component-on-board, such as a conduit cartridge. The fluid may return from the component-on-board to the fluid handling substrate through an additional port or orifice as described below. One skilled in the art given the benefit of this disclosure will be able to interface the fluid-handling substrates described here with any of numerous devices including but not limited to analytical systems and conduit cartridges.

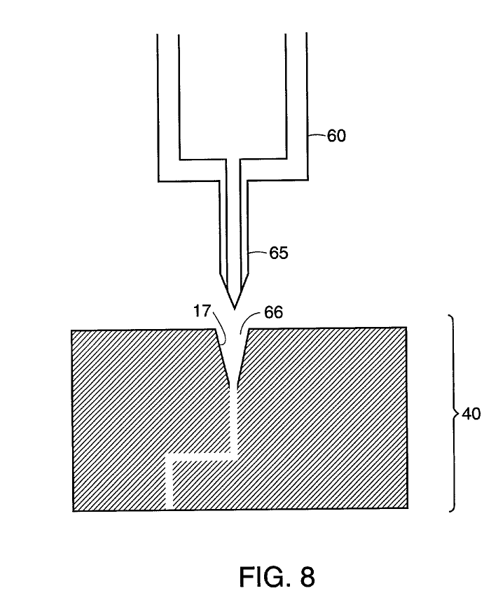

In accordance with certain preferred embodiments, FIGS. 7A and 7B shows one possible configuration for assembly of a fluid-handling substrate with a component-on-board. Referring to FIG. 7A, a component-on-board 50 is attached to a provided assembled fluid-handling substrate 40 through a port 17 on the surface of the substrate. Referring to FIG. 7B, the interface of the component-on-board and the port are selectively welded together using any method known to those skilled in the art, for example, selective IR welding using an EM beam 31 as discussed above. Upon completion of the selective IR welding, a fluid tight seal is created between the component-on-board 50 and port 17 on substrate 40. The component-on-board may then be in fluid communication with an internal channel 13 of the welded substrate and any environmentally sensitive elements 14 contained therein. Certain preferred embodiments of the microfluidic substrate assemblies disclosed here comprise a removable component-on-board attached to an assembled fluid-handling substrate. A removeable component-on-board facilitates exchanging or swapping one component-on-board for another. The ability to exchange with other swappable components-on-board provides increased functionality to the fluid-handling substrate. For example, the swappable component-on-board may contain a device, such as a UV-Visible detector, to analyze chemical or biological components contained within the fluid-handling substrate. The UV-Visible detector could then be removed and replaced with another type of detector, such as an infrared detector, for a more complete and distinct analysis of the species in the fluid contained within or delivered from the fluid handling substrate. For illustrative purposes only, FIG. 8 shows an embodiment of a fluid-handling substrate containing a swappable component-on-board. The fluid-handling substrate of FIG. 8 may be assembled using any technique described above or any technique known to those skilled in the art. Though not drawn to scale, a swappable component-on-board 60 attaches to the fluid-handling substrate through a port 17 on the surface of an assembled fluid-handling substrate 40. The port optionally contains one or more connectors as described above. To facilitate attachment and maintenance of the desired fluid-tight seal, the swappable component-on-board 60 typically contains at least one connector. Additionally, the port 17 of the fluid-handling substrate 40 may contains at a gasket and a connector for accepting the connector from the swappable component-on-board. For example, the embodiment of FIG. 8 shows a swappable component-on-board 60 containing a male connector 65 and the port 17 of the fluid-handling substrate 40 containing a female connector 66. The joint or interfacial areas of the connector 65 of the component-on-board 60 and the connector 66 of the port 17 act to form a fluid tight seal. After creating a fluid-tight seal between the swappable component-on-board and the fluid-handling substrate, effective fluid communication is established between any internal channels and any environmentally sensitive component contained within the fluid-handling substrate and the component-on-board. One skilled in the art given the benefit of this disclosure will be able to select suitable connectors and devices for creating fluid tight seals between swappable components-on-board and the fluid-handing substrate assemblies disclosed here.

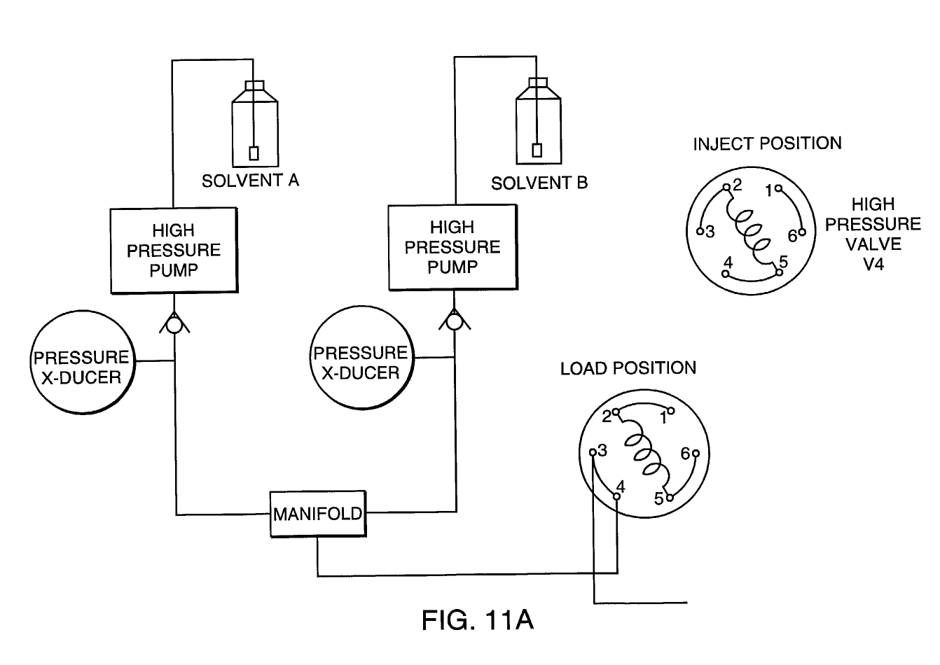

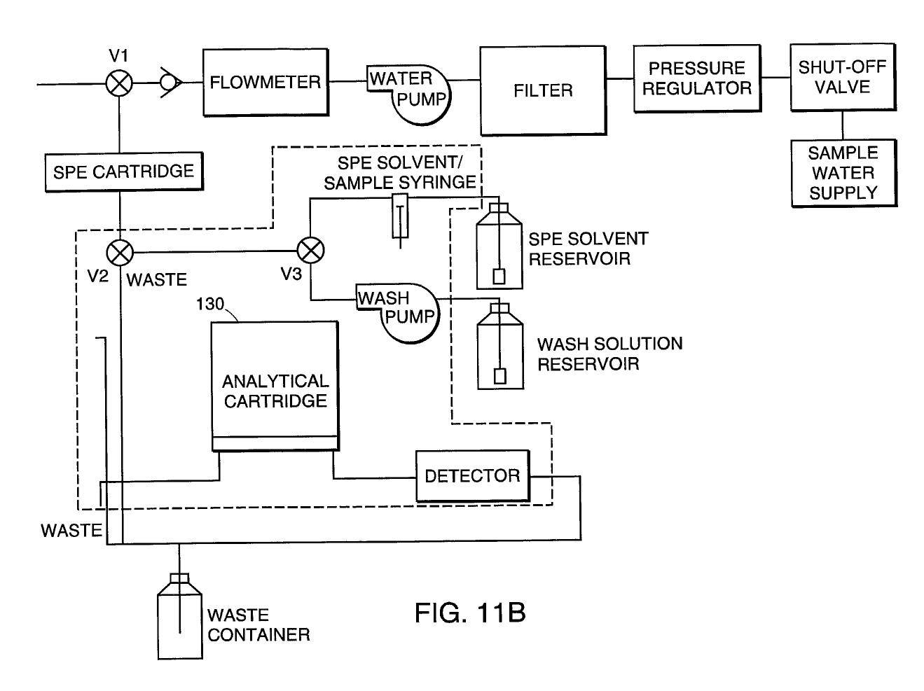

In accordance with preferred embodiments, the multi-layer laminated substrates disclosed here may be used in a chromatographic instrument. For example, a microchannel of the substrate may be coated with a packing material such that the substrate is operative as an analytical cartridge, e.g. see 130 in FIG. 11B. Referring to FIGS. 11A and 11B, the analytical cartridge may be used, for example, to separate multiple species in a fluid. The sample can be introduced into the system using an injector, and a suitable mobile phase can be selected and introduced using solvent reservoirs and high pressure pumps. Preferably solvent gradients are implemented to achieve more efficient and better separation. In addition, the analytical cartridge can be in communication with a sample supply line, e.g. a waste line flowing out of manufacturing facility into a body of water, such that samples may be taken automatically and intermittently, e.g. hourly, daily, weekly and the like, and separated by the analytical cartridge using, for example, additional solid phase extraction (SPE) cartridges, pre-concentrators, guard columns, pumps, and the like in fluid communication with the analytical cartridge 130. Suitable separation systems for use with embodiments of the multi-layer laminated substrate disclosed here will be apparent to those skilled in the art. Exemplary analytical systems are discussed below in the Examples.

From the above disclosure and detailed description of various preferred embodiments, it will be recognized by those skilled in the art, that good flexibility is achieved in the design, manufacture and use of fluid-handling substrates suitable for can be used for a variety of applications including, but not limited to, liquid chromatography separations and analyses. The use of fixed and/or removeable or swappable components-on-board provides additional functionality to the fluid-handling substrates. Fabrication of the substrate and its components using PEEK provides design flexibility and good opportunity for quality assurance in the assembly process.

Several examples of a fluid separation conduit cartridge are described below. The examples are not intended to limit the fluid separation conduit cartridges described here in any manner.

### EXAMPLE 1

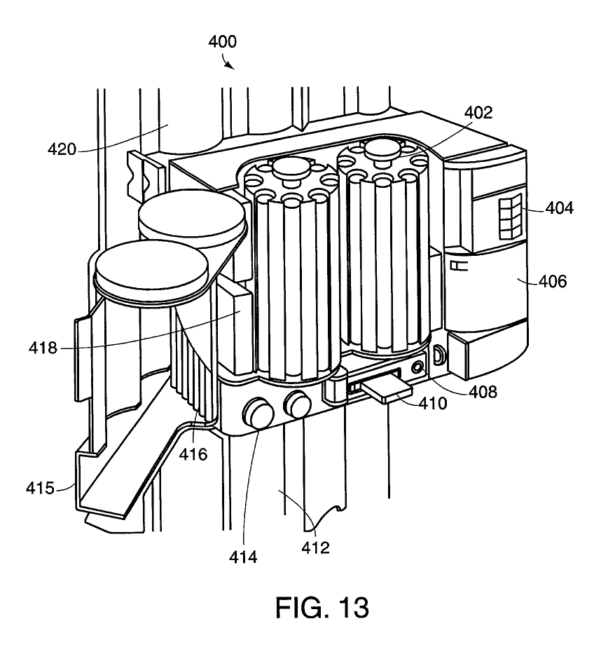

An example of a fluid-handling substrate assembly, in the form of a fluid separation conduit cartridge, interfaced with an analytical system, e.g. a chromatography system, is shown in FIG. 13. The analytical system typically is positioned within an end-user's facility for automated analyses. That is, the analytical system may be positioned near, or in-line, e.g. within the sample flow itself, such that analysis of samples may occur automatically, e.g. using auto-samplers, auto-injectors, and the like, or to facilitate rapid analysis of samples, e.g. samples during a process by an operator at an end-user's facility. For example, the system can be configured for analysis at specified intervals, e.g. every minute, hour, day, etc., such that continuous monitoring of a process can be performed with little or no user input. That is, the system can be configured to run a chromatographic method at a specified time interval without additional input from an operator. Referring to FIG. 13, the analytical system 400 typically comprises a multi-layer laminated conduit cartridge 410 interfaced with an analytical system, e.g. a chromatography instrument. Numerous mechanisms for interfacing the conduit cartridge with the analytical system are known to those skilled in the art and exemplary interfaces are described below. The multi-layer laminated conduit cartridge may be designed using the methods described above, for example, by etching microchannels into two or more layer of PEEK and assembling the layers, using selective IR welding for example, to form a microfluidic flow channel at the interface of the layers. Subsequently, a packing material may be introduced into the conduit cartridge to form a separation conduit cartridge operative to separate species in a fluid. The analytical system optionally comprises a treatment unit 402, such as a filter, a guard column, a solid phase extraction silo for analyte pre-concentration, etc. The analytes may be pre-concentrated such that trace levels of analyte are concentrated to levels that are detectable by the analytical system.

That is, the concentration of an analyte maybe increased 10¹, 10², 10³ 10⁴, 10⁵, 10⁶, 10⁷, 10⁸, 10⁹ times or higher to levels that are easily detected using the detector of the analytical system. The treatment units are optional and may be replaced with other chromatographic devices, such as, for example, guard columns, filters, semi-permeable membranes, etc. Alternatively, the treatment units can be replaced with a fluid flow channel such that little or no operations are performed on the fluid prior to entry into the conduit cartridge.

The system also typically includes a graphical user interface 404 for programming the system, e.g. the method, and/or monitoring system performance. The graphical interface may take numerous forms such as, for example, a keypad, an LCD screen, a touch screen, e.g. a touch screen display unit, etc. In certain embodiments, the graphical user interface is omitted and the information on the conduit cartridge is used to program the system. The system optionally contains a receiver/transmitter 406 to provide for remote operation and diagnosis, e.g. operation of the analytical system over the Internet and/or transmission of data over the Internet to a remote facility. In certain embodiments, the conduit cartridge itself comprises a receiver/transmitter, and thus the receiver/transmitter of the analytical system may be omitted.

The system typically includes at least one detector 408. The type of detector used typically depends on the optical and physical properties of the species in the fluid. Additionally, the detectors are usually interchangeable such that the detector may be switched to a different type of detector, e.g. from a UV-Visible absorbance detector to a fluorescence detector. Suitable detectors include but are not limited to UV-Visible absorbance detectors, IR detectors, fluorescence detectors, electrochemical detectors, voltammetric detectors, coulometric detectors, potentiometric detectors, thermal detectors, ionization detectors, NMR detectors, EPR detectors, Raman detectors, refractive index detectors, ultrasonic detectors, photothermal detectors, photoacoustic detectors, evaporative light scattering detectors, mass-spectrometric detectors, and the like. The conduit cartridge 410 typically interfaces with the system through a manifold, which is discussed in detail below. In alternative embodiments, however, the conduit cartridge can interface directly with the system, e.g. can be connected directly to a fluid supply source, e.g. a pump and/or injector, without any intervening mechanical components, for example.

A closeable face plate 415 maybe hingeably or removably attached to the system and can be closed over, or around, the system to protect the system from harsh environmental conditions, such as chemical solvents, UV radiation and the like. Supplying power and data to the chromatography system is a power and communication interface 416. Such interfaces typically are operative to provide a power source to the system, and can also provide communication of the system to a central computer, e.g. a computer in communication with the system for monitoring test results and/or for receiving information from the system.

To achieve high reproducibility, a fixed-loop injector 414 is typically used to introduce sample into the system. Suitable fixed-loop injectors are well known to those skilled in the art and are commercially available from numerous sources, e.g. Beckman Instruments (Fullerton, Calif.). Other injectors maybe used in place of the fixed-loop injector depending on the intended use of the system. For example, auto-injectors and/or auto-samplers may be used to provide for automated sampling and analysis of fluids. Suitable auto-samplers and auto-injectors are well known to those skilled in the art and are commercially available from numerous manufacturers. Optionally, the system can be programmed such that the auto-samplers and/or auto-injectors take samples at specified intervals, e.g. every 10 seconds, every minute, hourly, daily, weekly, monthly, etc., such that testing of the fluid can be performed without any input from a user. The system also includes precise microfluidics for accurate solvent gradients and includes solvent reservoirs and/or reagent magazines 418 for providing a fluid phase for running the chromatographic methods of the conduit cartridge, e.g. solvent gradients and the like. Such precise microfluidics can be achieved using numerous methods known to those skilled in the art, such as the methods described in the commonly assigned U.S. Patent Applications incorporated herein by reference for all purposes. As discussed above, typically in fluid communication with the solvent reservoirs are one or more pumps, which are operative to generate a fluid flow.

Typically the system installation can be customized such that the system can be positioned in numerous places in a facility. That is, the dimensions and shapes of the system can be designed for placement of the system in numerous areas of an operating facility, and the functions, e.g. the chromatographic methods, of the system can be tailored to perform innumerable tests desired by an end-user. In preferred embodiments, the system is placed near the sample or process to be monitored. That is, the system may be placed, either fixably or removably mounted, for example, near the fluid to be analyzed. For example, the system can be custom mounted to a conduit 420 that carries a fluid sample, e.g. river water, out of a manufacturing facility, for example. Depending upon the configuration of the system, the system can automatically sample the fluid flowing through the conduit, e.g. using an auto-sampler, auto-injector and the like, or one or more valves positioned in the conduit can be connected to the analytical system for introducing samples into the system. Alternatively, an operator can manually take samples from the conduit and can introduce the samples through a fixed-loop injector, for example, using a needle, syringe, and the like. One skilled in the art given the benefit of this disclosure will be able to select suitable positions for the system described here depending on the type of analyses to be performed by the system.

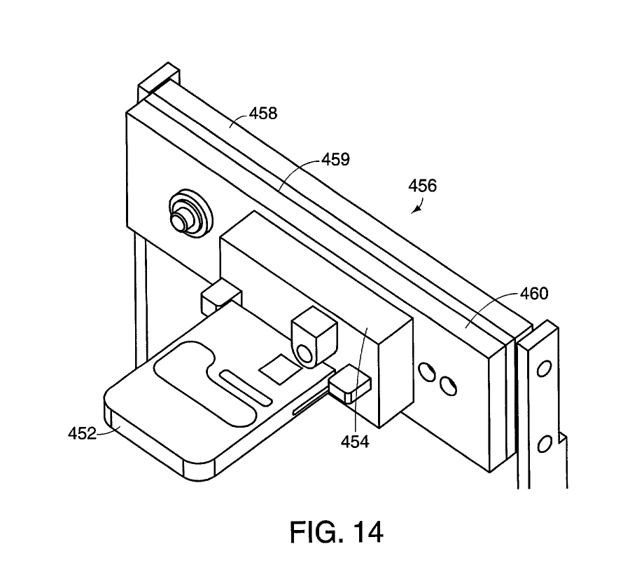

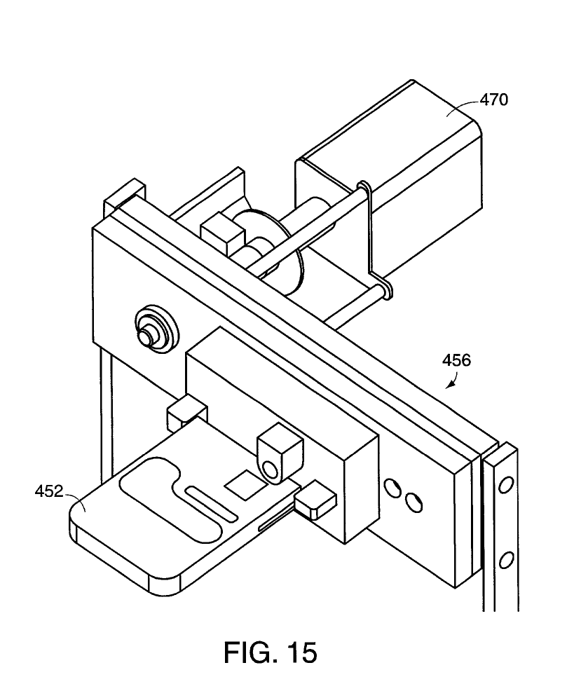

The fluid separation conduit cartridge typically interfaces with an analytical system through a manifold, e.g. the multi-layer laminated manifold 456 shown in FIG. 14. Multi-layer manifold 456 may be assembled using any of the methods described above and other methods know to those skilled in the art. In FIG. 14, the conduit cartridge 452 will be understood to be analogous to conduit cartridge 410 shown in FIG. 13. Thus, FIG. 10 shows a first multi-layer laminated assembly, e.g. the conduit cartridge 452, interfaced to a second multi-layer laminated assembly, the manifold 456. As discussed, the manifold 456 is seen in the particular embodiment of FIG. 14 to be a multi-layer laminated structure and has one or more microfluidic channels for introducing fluid into or receiving fluid from the conduit cartridge. For example, the manifold 456 may comprise a first layer 458 attached to a second layer 459 which itself is attached to a third layer 460. As can be seen in FIG. 10, the second layer 459 typically is sandwiched between the first layer 458 and the third layer 460. Fluid channels can be provided within and/or at the interface(s) of the layers of such manifolds. For example, layer 459 in the manifold 456 of FIG. 14 can optionally be constructed as a microfluidic substrate assembly as described above, optionally with layer 459 being formed substantially of PEEK. The layers of the multi-layer laminated manifold each can be manufactured from any of numerous materials, including but not limited to PEEK, steel, e.g. stainless steel, and the like. Different layers of the multi-layer laminated manifold may be formed of different materials. In certain embodiments, the microfluidic flow channel is between two or more of the layers, e.g. the microfluidic flow channel can extend from the third layer into the second layer and optionally into the first layer, for example. The microfluidic flow channel can be formed in one or more of the layers using numerous techniques, e.g. UV embossing, micro-machining, micro-milling, and the like. For example, a micro-channel can be etched into the second layer and the first layer such that when the second layer is assembled to the first layer a fluid-tight microfluidic flow channel is created. As discussed above, the layers can be assembled to form the multi-layer laminated manifold. For example, the layers can be assembled by welding the layers together, optionally with a gasket positioned between the layers, or can be assembled using adhesives and the like. One skilled in the art given the benefit of this disclosure will be able to select suitable methods for assembling the layers of multi-layer laminated manifolds suitable for use with multi-layer conduit cartridges disclosed here. Preferably, the manifold comprises at least a first microfluidic channel in fluid communication with a solvent reservoir and with an input orifice of the conduit cartridge. Thus solvent may flow into the conduit cartridge through a microfluidic channel in the manifold, e.g. by pumping the fluid into the cartridge using a pump. The manifold can include a second microfluidic channel that is in fluid communication with an output orifice of the conduit cartridge and typically is also in fluid communication with a detector. Therefore, a sample maybe introduced into the conduit cartridge through the first micro fluidic channel in the multi-layer manifold, separated by the conduit cartridge, and the separated species can flow out of the conduit cartridge through the second microfluidic channel in the manifold to a detector that can measure the amount and nature of the species present in the sample. Thus, as discussed above, the fluid handling substrates described here may be configured to interface with an analytical system in numerous ways, e.g. a manifold 456 or a conduit cartridge 452 or both. One skilled in the art given the benefit of this disclosure will be able to design other suitable manifolds and devices for interfacing the conduit cartridge with an analytical system.

The multi-layer manifold may also contain an interface 454 mounted to the manifold. The interface 454 typically is operative to create a fluid-tight seal when the cartridge is plugged into the manifold. That is, interface 454 is operative to provide a sealing force suitable to prevent fluid from leaking between the manifold and the fluid separation conduit cartridge. Optionally, one or more gaskets can be positioned between the conduit cartridge and the interface to aid in forming a fluid-tight seal. The interface itself may comprise a multi-layer laminated structure. Thus, in certain embodiments, a plurality of multi-layer laminated structures may be in fluid communication with each other, through microchannels, ports, and the like, and with one or more analytical systems. One skilled in the art, given the benefit of this disclosure, will be able to select suitable manifolds, interfaces and mechanisms for retaining the conduit cartridge against the manifold and/or interface of the manifold to create a fluid-tight seal. Exemplary mechanisms include cams, springs, pressure plates, welding, clamps, gear drives, and combinations of any of them, adapted to be actuated by gravity or manually, by solenoid, pneumatically, hydraulically, etc. As discussed above, in alternative embodiments the conduit cartridge is plugged directly into the system without using a manifold. For example, suitable connectors may be added to the conduit cartridge such that the conduit cartridge can be in direct fluid communication with a flow line, e.g. a flow line including one or more solvents and one or more species to be separated. One skilled in the art given the benefit of this disclosure will be able to select suitable mechanisms and devices for interfacing the conduit cartridge disclosed here to an analytical system.

In other embodiments, the manifold itself is in communication with a second component-on-board, such as a device that is operative to generate fluid flow. For example, referring to FIG. 15, a pump 470 can be attached to the multi-layer laminated manifold 456 and can be configured such that fluid is drawn from a fluid reservoir, e.g a solvent reservoir, and is forced into manifold 456 and subsequently into conduit cartridge 452. Such devices may be any of the devices known to those skilled in the art and discussed above including but not limited to pumps, vacuum manifolds and the like. The device for generating fluid flow can also be in communication with one or more injectors as discussed above.

### EXAMPLE 2

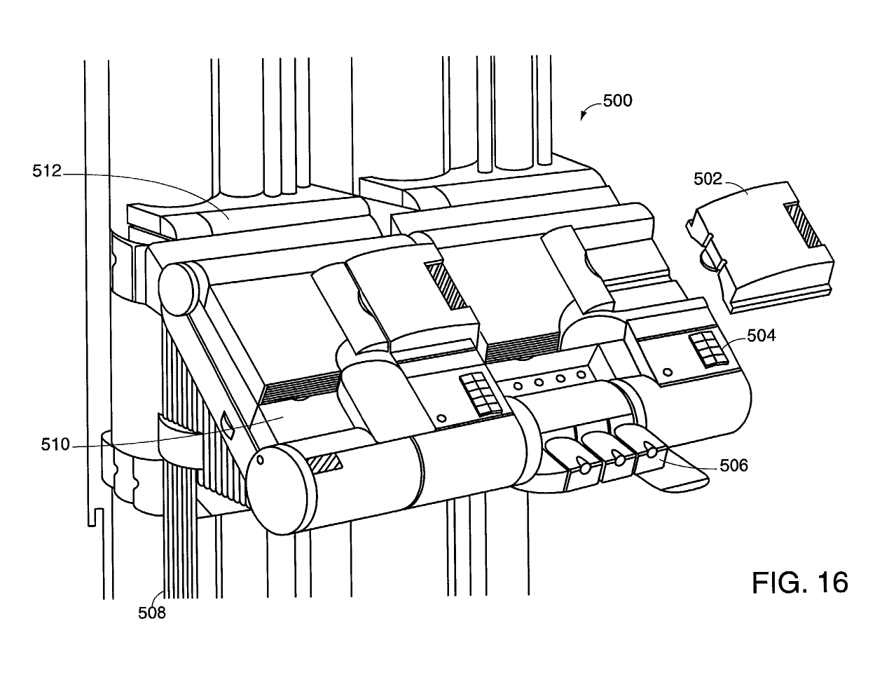

An additional example of a multi-layer laminated conduit cartridge, assembled in accordance with this disclosure, interfaced with an analytical system is shown in FIG. 16. The analytical system 500 comprises a conduit cartridge 502, e.g. a cartridge operative to perform capillary liquid chromatography, a graphical user interface 504, and buffer cassettes 506. The graphical user interface can be used to program the system and/or the conduit cartridge for a specific method, e.g. a specific solvent gradient, run time, flow rate, and the like. As discussed above, the graphical user interface can be omitted in embodiments where the conduit cartridge is operative to program the system, e.g. where the conduit cartridge comprises an analytical method in a memory unit within the conduit cartridge, for example. The buffer cassettes are equivalent to solvent reservoirs. That is, the buffer cassettes may be loaded with any suitable mobile phase needed to perform a chromatographic method, for example. Preferably, the mobile phases are different in different buffer cassettes such that solvent gradients can be implemented in the analytical method. The buffer cassettes may be in communication with one or more devices that are operative to generate a fluid flow (not shown), e.g. pumps and the like. The system 500 typically has one or more power and communication interfaces 508 and can be custom installed 512 at a user's facility such that automated analyses may take place or such that the system is positioned near the fluid to be analyzed. As discussed above, the communication interface may send and/or receive data to or from a central computer, or other device. The system can be controlled by remote operation and diagnosis using a communication device 510 by various methods, such as for example, e-mail over the Internet. The communication device typically is used to alter the method of the system without having to manually enter the new method using the graphical user interface. This feature provides for remote configuration, or reconfiguration as the case may be, of the system. In certain embodiments, the communication device is omitted and the system is controlled by information sent from the conduit cartridge, which may comprise its own communication device positioned with a chamber in the conduit cartridge, to the system. As can be seen in FIG. 16, the size of the conduit cartridge can be tailored such that it has the appropriate dimensions, e.g. height, width and thickness, and has the appropriate connectors to interface with any analytical system. For example, in embodiments comprising a capillary column, the dimensions of the conduit cartridge maybe reduced such that the footprint of the cartridge is smaller and occupies less space on the analytical system. Suitable fluid connectors including those discussed here, e.g. male/female connectors and the like, can be attached to the conduit cartridges and are typically operative to create a fluid-tight seal between the conduit cartridge and the analytical system. Suitable electrical connectors can be attached to the conduit cartridge including those discussed above, for example, PCMCIA connectors, USB connectors, serial connectors and the like. The electrical connectors typically provide for transfer of information to and from the conduit cartridge.

As discussed above, the fluid separation conduit cartridge can interface with the system through a manifold, such as the manifold shown in FIG. 14, or can interface with the system directly, e.g. without any intervening physical components. Suitable connectors for interfacing with the manifold can be positioned on any surface of the housing unit of the conduit cartridge. The fluid separation conduit cartridge 502 may include one or more connectors on a major surface, e.g. the back surface of the conduit cartridge 502 shown in FIG. 16, such that the conduit cartridge can interface with a manifold and sit flush with the surface of the system. For example, the conduit cartridge may have outwardly projecting connectors that plug into a manifold, having receiving sockets, positioned on the analytical system. When the conduit cartridge is plugged into the manifold, the conduit cartridge snaps into position on the analytical system, e.g. becomes seated in a slot on the surface of the analytical system. Thus, the conduit cartridge is in fluid communication with the analytical system and is retained by the system such that vibrations will not dislodge the conduit cartridge from the system, i.e. the conduit cartridge remains in fluid communication with the system even in the presence of vibrations or other physical disturbances. Numerous other devices, e.g. cams, pulleys, springs, pressure plates and the like may be used to retain the conduit cartridge against the manifold of the system such that a fluid tight seal is preserved.

Although the present invention has been described above in terms of specific embodiments, it is anticipated that other uses, alterations and modifications thereof will become apparent to those skilled in the art given the benefit of this disclosure. Such alterations are intended to include the interchanging of one or more of the components of any of the embodiments with the components of any of the other embodiments disclosed here. It is intended that the following claims be read as covering such alterations and modifications as fall within the true spirit and scope of the invention. It is intended that the articles “a” and “an”, as used below in the claims, cover both the singular and plural forms of the nouns which the articles modify.

What is claimed is:

1. A microfluidic substrate assembly comprising:
a multi-layer laminated substrate defining at least one fluid inlet port and at least one microscale fluid flow channel within the multi-layer substrate in fluid communication with the inlet port for transport of fluid; and
at least one operative component mounted aboard the multi-layer laminated substrate in communication with the microscale fluid flow channel.

2. The microfluidic substrate assembly of claim 1 in which the operative component mounted aboard the multi-layer laminated substrate is in fluid communication with the at least one microscale fluid flow channel.

3. The micro fluidic substrate assembly of claim 2 in which the operative component mounted aboard the multi-layer laminated substrate is operative as a fluid reservoir.

4. The micro fluidic substrate assembly of claim 1 in which the operative component mounted aboard the multi-layer laminated substrate is operative as a light sensor across a microscale fluid flow channel within the multi-layer substrate.

5. The micro fluidic substrate assembly of claim 1 in which the operative component mounted aboard the multi-layer laminated substrate is operative as an ultrasonic actuator or transducer across a microscale fluid flow channel within the multi-layer substrate.

6. The microfluidic substrate assembly of claim 1 in which the operative component mounted aboard the multi-layer laminated substrate is operative to generate fluid pressure in a microchannel of the substrate.

7. The microfluidic substrate assembly of claim 6 in which the operative component mounted aboard the multi-layer laminated substrate is a thermal actuator.

8. The microfluidic substrate assembly of claim 6 in which the operative component is a micromachined pump, diaphragm pump, syringe pump or volume occlusion pump.

9. The microfluidic substrate assembly of claim 1 in which the operative component mounted aboard the multi-layer laminated substrate is operative to induce flow in a microchannel of the multi-layer laminated substrate endosmotically or by electrochemical evolution of gases.

10. The microfluidic substrate assembly of claim 1 in which the multi-layer laminated substrate further comprises at least one fluid outlet port in fluid communication with the fluid inlet port within the multi-layer substrate.

11. The microfluidic substrate assembly of claim 1 in which the operative component mounted aboard the multi-layer laminated substrate is at least one electronic memory unit mounted to the substrate assembly and operatively connected to the microfluidic substrate assembly.

12. The microfluidic substrate assembly of claim 11 further comprising at least one operative component mounted aboard the multi-layer laminated substrate in communication with the microscale fluid flow channel and operative to generate an electronic signal corresponding to a detected characteristic of fluid in the microscale fluid flow channel, wherein the at least one electronic memory unit is connected to the operative component to receive and record the electronic signal.

13. A microfluidic substrate assembly comprising a generally planar multi-layer laminated substrate defining
at least one fluid inlet port and at least one microscale fluid flow channel at each of more than one level within the multi-layer laminated substrate for transport of fluid, and
at least one microchannel via extending between levels within the multi-layer laminated substrate for fluid communication between microscale fluid flow channels of different levels.

14. The microfluidic substrate assembly of claim 13 in which the at least one microchannel has a configuration which is straight, curvo-linear, serpentine or spiral.

15. A microfluidic substrate assembly comprising a multi-layer laminated substrate defining at least one fluid inlet port and at least one microscale fluid flow channel in fluid communication with the inlet port for transport of fluid, wherein at least one layer of the multi-layer laminated substrate is formed of plastic and the substrate assembly is operative and fluid tight at fluid pressure in the microscale fluid flow channel in excess of about 100 psi.

16. The microfluidic substrate assembly of claim 15 in which the multi-layer laminated substrate is operative and fluid tight at fluid pressure in the microscale fluid flow channel in excess of about 1000 psi.

17 The microfluidic substrate assembly of claim 15 in which the multi-layer laminated substrate further comprises rigid plates sandwiching the plastic layer between them.

18. The microfluidic substrate assembly of claim 17 in which multiple layers of the multi-layer laminated substrate are formed of plastic and are welded one to another, the rigid plates sandwiching the multiple plastic layer between them.

19. The microfluidic substrate assembly of claim 18 in which the multiple plastic layers of the multi-layer laminated substrate are selectively welded one to another to form a fluid-tight seal along a channel within the substrate.

20. A microfluidic substrate assembly comprising a multi-layer laminated substrate defining at least one fluid inlet port and at least one microscale fluid flow channel within the multi-layer substrate in fluid communication with the inlet port for transport of fluid, in which at least one layer of the multi-layer laminated substrate is formed of PEEK.

21. The microfluidic substrate assembly of claim 20 in which the at least one PEEK layer is formed of amorphous PEEK.

22. The microfluidic substrate assembly of claim 20 in which the at least one PEEK layer is formed of crystalline PEEK.

23. The microfluidic substrate assembly of claim 20 in which the at least one PEEK layer comprises IR absorbing species in concentration sufficient for IR welding of the PEEK layer.

24. The microfluidic substrate assembly of claim 23 in which the IR absorbing species is distributed substantially homogeneously throughout the PEEK layer.

25. The microfluidic substrate assembly of claim 23 in which the IR absorbing species is disposed on the surface of the PEEK layer.

26. The microfluidic substrate assembly of claim 25 in which the IR absorbing species is selected from dyes, zinc oxide, silicon oxide and metal species.

27. A microfluidic substrate assembly comprising a multi-layer laminated substrate defining at least one fluid inlet port and at least one microscale fluid flow channel within the multi-layer substrate in fluid communication with the inlet port for transport of fluid, wherein at least first and second layers of the multi-layer laminated substrate are selectively welded to each other to form a fluid-tight seal at least along a channel within the multi-layer laminated substrate.

28. The microfluidic substrate assembly of claim 27 in which the multi-layer laminated substrate further comprises at least one environmentally sensitive structure intolerant to a transition glass temperature of the first and second layers.

29. The microfluidic substrate assembly of claim 28 in which the environmentally sensitive structure is an architectural feature of the microscale fluid flow channel, a mechanical sensor, a mechanical device, an electrical sensor, an electrical device, a fluid, chromatography reagents and any combination of them.

30. The microfluidic substrate assembly of claim 28 in which the environmentally sensitive structure is disposed in the microscale fluid flow channel.

31. A method of producing a multi-layer laminated substrate, comprising the steps of:
forming a surface-to-surface interface by aligning a surface of a first substrate component against a surface of a second substrate component to form a substrate subassembly having an internal fluid channel at the interface; and
exposing the sub-assembly to radiation to heat only one or more selected portions of the interface to a temperature sufficient to weld the substrate components together, to form a fluid-tight seal between the substrate components at the interface along the fluid channel.

32. The method of claim 31 further comprising the steps of coating at least a selected area of the surface of the first substrate component with a radiation absorptive material prior to forming the surface-to-surface interface.

33. The method of claim 32 in which the absorptive material is coated onto only one or more selected portions of the surface of the first substrate component and the sub-assembly is exposed non-selectively to IR radiation.

34. The method of claim 32 in which the absorptive material is coated onto the entire surface of the first substrate component and only one or more selected portions of the interface are exposed to IR radiation.

35. The method of claim 34 in which the sub-assembly is exposed to radiation through a mask having a configuration corresponding to the one or more selected portions of the interface.
